(19) United States
(12) Patent Application Publication
(10) Pub. No.: US 2019/0356412 A1
(43) Pub. Date: Nov. 21, 2019

(54) FAST TERMINATION OF MULTILANE DOUBLE DATA RATE TRANSACTIONS

(71) Applicant: QUALCOMM Incorporated, San Diego, CA (US)

(72) Inventors: Radu PITIGOI-ARON, San Jose, CA (US); Sharon GRAIF, Zichron Yakov (IL); Richard Dominic WIETFELDT, San Diego, CA (US)

(21) Appl. No.: 16/381,415

(22) Filed: Apr. 11, 2019

Related U.S. Application Data
(60) Provisional application No. 62/672,425, filed on May 16, 2018.
(60) Provisional application No. 62/695,584, filed on Jul. 9, 2018.
(60) Provisional application No. 62/717,501, filed on Aug. 10, 2018.

(51) Int. Cl. H04L 1/00; G06F 13/42

(52) U.S. Cl. CPC H04L 1/0041; G06F 13/4282; H04L 1/0061

(57) ABSTRACT

Systems, methods, and apparatus are described that enable a serial bus to be operated in one or more modes that employ additional wires for communicating data. A method includes providing a data payload for a data frame to be transmitted over a plurality of data lanes of a multilane serial bus, providing a preamble to precede the data payload in transmission over the multilane serial bus, configuring one or more repurposed bit fields in the data frame to indicate that a multi-bit cyclic redundancy check is provided in the data frame, and transmitting the data frame over the multilane serial bus in accordance with a clock signal transmitted on a clock lane of the multilane serial bus. At least one bit of the multi-bit cyclic redundancy check is transmitted on two or more data lanes of the plurality of data lanes.

### PRIORITY CLAIM

This application claims priority to and the benefit of U.S. Provisional Patent Application Ser. No. 62/672,425 filed in the U.S. Patent Office on May 16, 2018, U.S. Provisional Patent Application Ser. No. 62/695,584 filed in the U.S. Patent Office on Jul. 9, 2018, and U.S. Provisional Patent Application Ser. No. 62/717,501 filed in the U.S. Patent Office on Aug. 10, 2018 the entire content of these applications being incorporated herein by reference as if fully set forth below in its entirety and for all applicable purposes.

### TECHNICAL FIELD

The present disclosure relates generally to an interface between processing circuits and peripheral devices and, more particularly, to optimizing data communication throughput on a serial bus.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

In one example, the Inter-Integrated Circuit serial bus, which may also be referred to as the I2C bus or the I²C bus, is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL).

In another example, the protocols used on an I3C bus derives certain implementation aspects from the I2C protocol. The I3C bus are defined by the Mobile Industry Processor Interface Alliance (MIPI). Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation.

As applications have become more complex, demand for throughput over the serial bus can escalate and capacity may be strained or exceeded. Multilane capabilities may be added to a serial bus, whereby more than two wires are used to couple devices. In one example, a first line carries a clock signal while two or more wires carry data timed in accordance with the clock signal. Multilane implementations can improve throughput for large transactions, but can increase latency when multilane data frames include padding.

### SUMMARY

Certain aspects of the disclosure relate to systems, apparatus, methods and techniques that support bus width expansion on a dynamic basis. Certain aspects relate to serial bus including a serial bus that may be operated in an I3C single data rate (SDR) mode of operation, an I3C double data rate (DDR) mode of operation, and/or an I3C ternary encoding mode of operation.

In various aspects of the disclosure, a method includes providing a data payload for a data frame to be transmitted over a plurality of data lanes of a multilane serial bus, providing a preamble to precede the data payload in transmission over the multilane serial bus, configuring one or more repurposed bit fields in the data frame to indicate that a multi-bit cyclic redundancy check is provided in the data frame, and transmitting the data frame over the multilane serial bus in accordance with a clock signal transmitted on a clock lane of the multilane serial bus. At least one bit of the multi-bit cyclic redundancy check is transmitted on two or more data lanes of the plurality of data lanes. In some examples, the multilane serial bus is operated in an I3C double data rate protocol.

In one aspect, the data frame is a read frame and the one or more repurposed bit fields are transmitted concurrently with parity for the data payload. In another aspect, the data frame is a write frame and the one or more repurposed bit fields are transmitted concurrently with parity information after transmission of the data payload. The one or more repurposed bit fields may include a cyclic redundancy check preamble.

In certain aspects, the multilane serial bus has a primary data lane and three additional data lanes. In one example, a fully-loaded data frame may carry four words as a data payload. Providing the data payload includes providing fewer than four valid data words as the data payload, and transmitting at least five bits in the multi-bit cyclic redundancy check. Transmission of the data frame may be terminated after transmitting the fewer than four valid data words. The transmission of the data frame may be transmitted early when the data frame includes fewer than a maximum number of data words configured for the data frame, and configuring the preamble with a value that indicates that a truncated data frame is being terminated early. The truncated data frame may include fewer than the maximum number of data words.

In various aspects of the disclosure, an apparatus has a bus interface configured to couple the apparatus to a multilane serial bus having a first data lane line and one or more additional data lanes, and a processor. The processor may be configured to provide a data payload for a data frame to be transmitted over a plurality of data lanes of a multilane serial bus, provide a preamble to precede the data payload in transmission over the multilane serial bus, configure one or more repurposed bit fields in the data frame to indicate that a multi-bit cyclic redundancy check is provided in the data frame, and transmit the data frame over the multilane serial bus in accordance with a clock signal transmitted on a clock lane of the multilane serial bus. At least one bit of the multi-bit cyclic redundancy check may be transmitted on two or more data lanes of the plurality of data lanes. In some examples, the multilane serial bus is operated in an I3C double data rate protocol.

In various aspects of the disclosure, an apparatus includes means for providing a data payload for a data frame to be transmitted over a plurality of data lanes of a multilane serial bus, means for providing a preamble to precede the data payload in transmission over the multilane serial bus, means for configuring one or more repurposed bit fields in the data frame to indicate that a multi-bit cyclic redundancy check is provided in the data frame, and means for transmitting the data frame over the multilane serial bus in accordance with a clock signal transmitted on a clock lane of the multilane serial bus. At least one bit of the multi-bit cyclic redundancy check may be transmitted on two or more data lanes of the plurality of data lanes. In some examples, the multilane serial bus is operated in an I3C double data rate protocol.

In various aspects of the disclosure, a processor-readable storage medium stores code for providing a data payload for a data frame to be transmitted over a plurality of data lanes of a multilane serial bus, providing a preamble to precede the data payload in transmission over the multilane serial bus, configuring one or more repurposed bit fields in the data frame to indicate that a multi-bit cyclic redundancy check is provided in the data frame, and transmitting the data frame over the multilane serial bus in accordance with a clock signal transmitted on a clock lane of the multilane serial bus. At least one bit of the multi-bit cyclic redundancy check may be transmitted on two or more data lanes of the plurality of data lanes. In some examples, the multilane serial bus is operated in an I3C double data rate protocol.

### BRIEF DESCRIPTION OF THE DRAWINGS

FIG. 1 illustrates an apparatus employing a data link between IC devices that is selectively operated according to one of plurality of available standards.

FIG. 2 illustrates a communication interface in which a plurality of devices is connected using a serial bus.

FIG. 3 illustrates certain aspects of an apparatus that includes multiple devices connected to a serial bus.

FIG. 4 includes a timing diagram that illustrates signaling on a serial bus when the serial bus is operated in a single data rate (SDR) mode of operation defined by I3C specifications.

FIG. 5 is a timing diagram that illustrates an example of a transmission of a frame in an I3C SDR mode.

FIG. 6 is a timing diagram that illustrates an example of a transmission of a frame in an I3C high data rate mode, where data is transmitted at double data rate (DDR).

FIG. 7 illustrates examples of signaling transmitted on the Data wire and Clock wire of a serial bus to initiate certain mode changes.

FIG. 8 illustrates a serial bus in which more than two connectors or wires may be available for timeshared communication between devices.

FIG. 9 illustrates data transmissions over a serial bus operated in an DDR mode when two or more devices can be coupled to additional connectors in accordance with certain aspects of this disclosure.

FIG. 10 illustrates read operations on a multilane serial bus that may be adapted in accordance with certain aspects of this disclosure.

FIG. 11 illustrates write operations on a multilane serial bus that may be adapted in accordance with certain aspects of this disclosure.

FIG. 12 is an example of a timeline illustrating the operation of a multilane-enabled serial bus.

FIG. 13 illustrates an example of a final frame in which a CRC word is transmitted at the end of a multilane write in accordance with certain aspects of the disclosure.

FIG. 14 illustrates the use of padding in read frames to maintain bus cadence when a serial bus is operated in accordance with certain aspects of this disclosure.

FIG. 15 illustrates first examples of early termination of read frames in accordance with certain aspects disclosed herein.

FIG. 16 illustrates second examples of early termination of read frames in accordance with certain aspects disclosed herein.

FIG. 17 illustrates the use of padding in write frames to maintain bus cadence when a serial bus is operated in accordance with certain aspects of this disclosure.

FIG. 18 illustrates first examples of early termination of write frames in accordance with certain aspects disclosed herein.

FIG. 19 illustrates second examples of early termination of write frames in accordance with certain aspects disclosed herein.

FIG. 20 illustrates third examples of early termination of write frames in accordance with certain aspects disclosed herein.

FIG. 21 illustrates fourth examples of early termination of write frames in accordance with certain aspects disclosed herein.

FIG. 22 illustrates an example of a truncated frames transmitted over a multilane I3C bus with a CRC provided in accordance with certain aspects disclosed herein.

FIG. 23 illustrates an example of a frame transmitted over a single data lane I3C bus with a CRC provided in accordance with certain aspects disclosed herein.

FIG. 24 is a block diagram illustrating an example of an apparatus employing a processing circuit that may be adapted according to certain aspects disclosed herein.

FIG. 25 is a flowchart illustrating a process that may be performed at a sending device coupled to a serial bus in accordance with certain aspects disclosed herein.

FIG. 26 illustrates a hardware implementation for a transmitting apparatus adapted to respond to support multi-lane operation of a serial bus in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a serial bus to connect application processor or other host device with modems and other peripherals. The serial bus may be operated in accordance with specifications and protocols defined by a standards body. The serial bus may be operated in accordance with a standard or protocol such as the I2C, I3C, serial low-power inter-chip media bus (SLIMbus), system management bus (SMB), radio frequency front-end (RFFE) protocols that define timing relationships between signals and transmissions. Certain aspects disclosed herein relate to systems, apparatus, methods and techniques that provide a mechanism that can be used on a serial bus to dynamically extend the bus width and thereby improve bandwidth and/or throughput. When the bus width is extended, data blocks or frames may be terminated early when insufficient data is available to form a complete data payload. Early termination can improve bus latency.

In this disclosure, the terms data block and data frame may be interchangeably used when describing a unit of data transferred over a serial bus. In one example, the data block/data frame includes one 16-bit word when transmitted using a single data wire of a serial bus operated in accordance with an I3C HDR DDR protocol. In another example, the data block/data frame can carry two 16-bit words when transmitted using two data wires of a multi-lane serial bus operated in accordance with an I3C HDR DDR protocol. In another example, the data block/data frame can carry four 16-bit words when transmitted using four data wires of a multi-lane serial bus operated in accordance with an I3C HDR DDR protocol.

Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similarly functioning device.

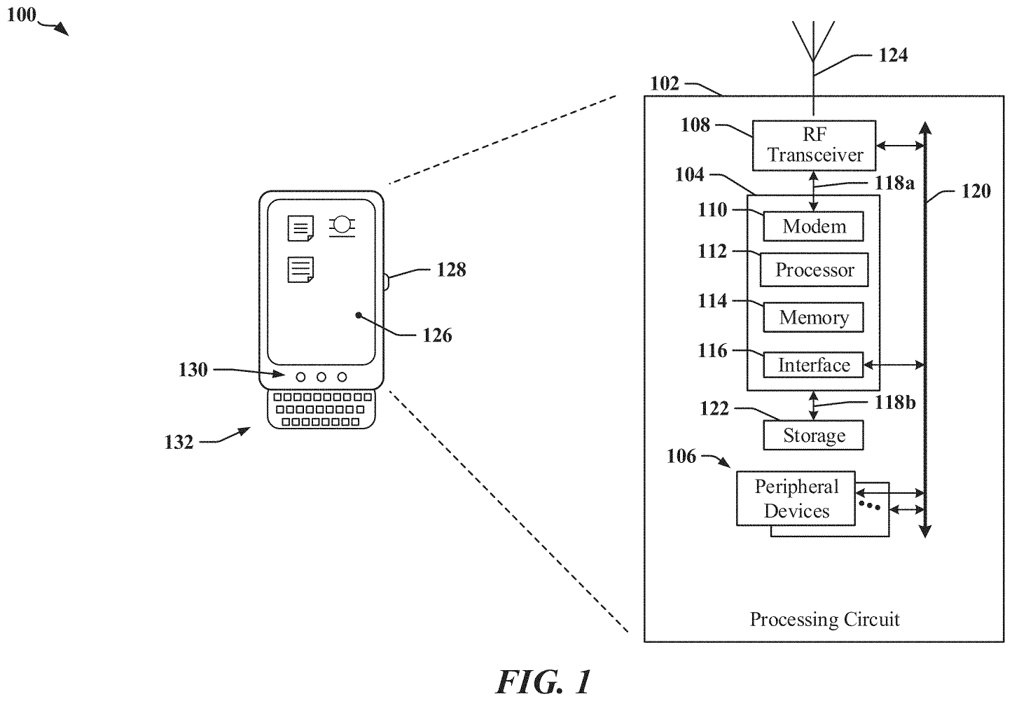

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, and other devices through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

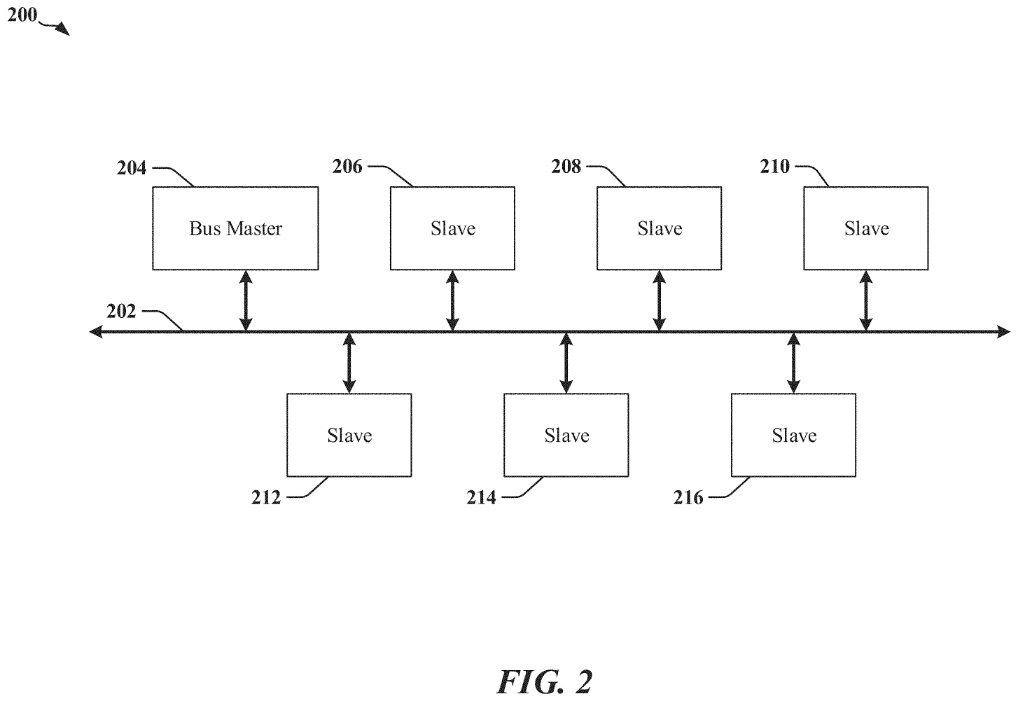

FIG. 2 illustrates a communication link 200 in which a configuration of devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols, where timing information is embedded in the transmission of the symbols.

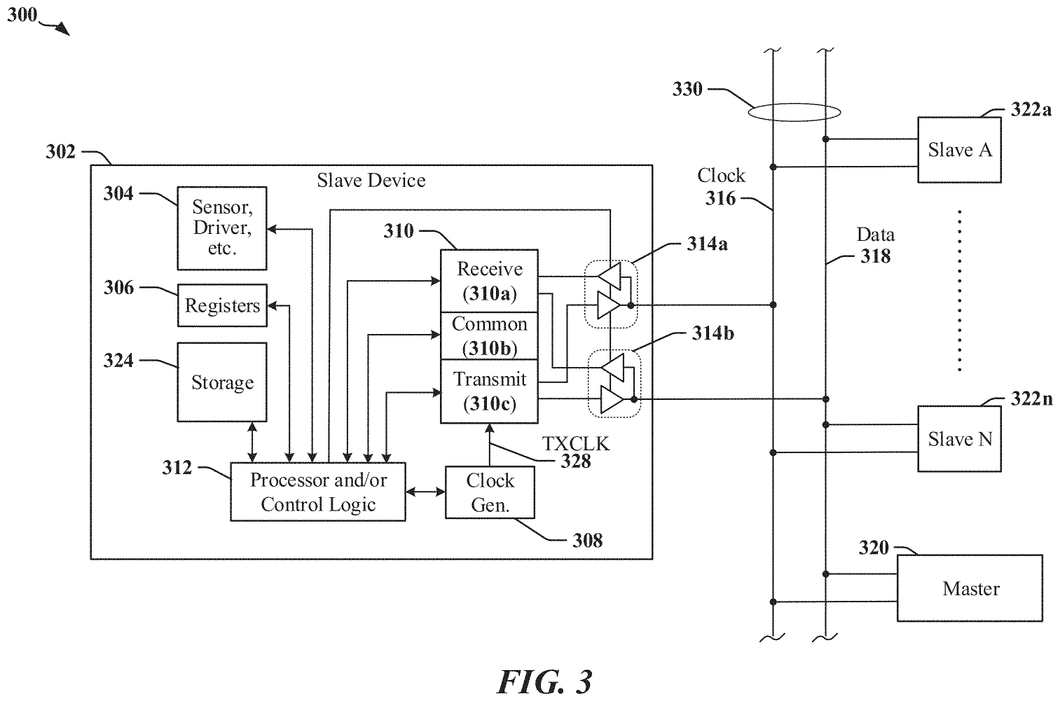

FIG. 3 illustrates certain aspects of an apparatus 300 that includes multiple devices 302, 320 and 322a-322n connected to a serial bus 330. The serial bus 330 may include a first wire 316 that carries a clock signal in certain modes of operation while a second wire 318 carries a data signal. In other modes of operation, data may be encoded in multi-bit symbols, where each bit of the symbol controls signaling state of one of the wires 316, 318. The devices 302, 320 and 322a-322n may include one or more semiconductor IC devices, such as an applications processor, SoC or ASIC. Each of the devices 302, 320 and 322a-322n may include, support or operate as a modem, a signal processing device, a display driver, a camera, a user interface, a sensor, a sensor controller, a media player, a transceiver, and/or other such components or devices. Communications between devices 302, 320 and 322a-322n over the serial bus 330 is controlled by a bus master 320. Certain types of bus can support multiple bus masters 320.

The apparatus 300 may include multiple devices 302, 320 and 322a-322n that communicate when the serial bus 330 is operated in accordance with I2C, I3C or other protocols. At least one device 302, 322a-322n may be configured to operate as a slave device on the serial bus 330. In one example, a slave device 302 may be adapted to provide a sensor control function 304. The sensor control function 304 may include circuits and modules that support an image sensor, and/or circuits and modules that control and communicate with one or more sensors that measure environmental conditions. The slave device 302 may include configuration registers 306 or other storage 324, control logic 312, a transceiver 310 and line drivers/receivers 314a and 314b. The control logic 312 may include a processing circuit such as a state machine, sequencer, signal processor or general-purpose processor. The transceiver 310 may include a receiver 310a, a transmitter 310c and common circuits 310b, including timing, logic and storage circuits and/or devices. In one example, the transmitter 310c encodes and transmits data based on timing provided by a clock generation circuit 308.

Two or more of the devices 302, 320 and/or 322a-322n may be adapted according to certain aspects and features disclosed herein to support a plurality of different communication protocols over a common bus, which may include an SMBus protocol, an SPI protocol, an I2C protocol, and/or an I3C protocol. In some examples, devices that communicate using one protocol (e.g., an I2C protocol) can coexist on the same serial bus with devices that communicate using a second protocol (e.g., an I3C protocol). In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 Mbps. I2C and I3C protocols may define electrical and timing aspects for signals transmitted on the 3-wire serial bus 330, in addition to data formats and aspects of bus control. In some aspects, the I2C and I3C protocols may define direct current (DC) characteristics affecting certain signal levels associated with the serial bus 330, and/or alternating current (AC) characteristics affecting certain timing aspects of signals transmitted on the serial bus 330.

### High-Speed Data Transfers Over an I3C Serial Bus

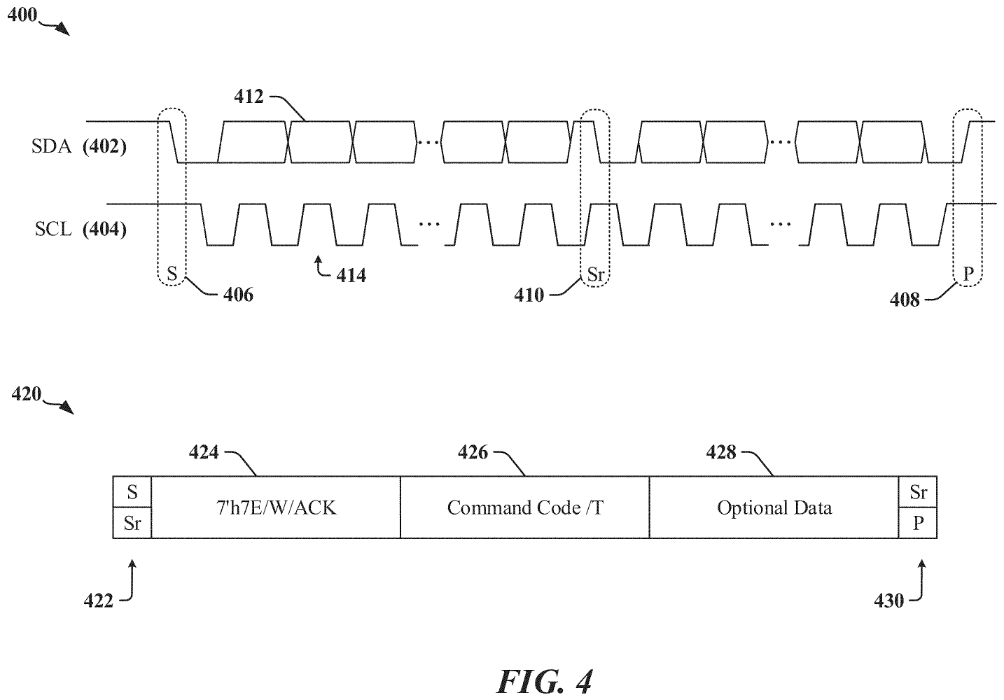

FIG. 4 includes a timing diagram 400 that illustrates signaling on a serial bus when the serial bus is operated in a single data rate (SDR) mode of operation defined by I3C specifications. Data transmitted on a first wire (the Data wire 402) of the serial bus may be captured using a clock signal transmitted on a second wire (the Clock wire 404) of the serial bus. During data transmission, the signaling state 412 of the Data wire 4 is expected to remain constant for the duration of the pulses 414 when the Clock wire 404 is at a high voltage level. Transitions on the Data wire 402 when the Clock wire 404 is at the high voltage level indicate a START condition 406, a STOP condition 408 or a repeated START 410.

On an I3C serial bus, a START condition 406 is defined to permit the current bus master to signal that data is to be transmitted. The START condition 406 occurs when the Data wire 402 transitions from high to low while the Clock wire 404 is high. The bus master may signal completion and/or termination of a transmission using a STOP condition 408. The STOP condition 408 is indicated when the Data wire 402 transitions from low to high while the Clock wire 404 is high. A repeated START 410 may be transmitted by a bus master that wishes to initiate a second transmission upon completion of a first transmission. The repeated START 410 is transmitted instead of, and has the significance of a STOP condition 408 followed immediately by a START condition 406. The repeated START 410 occurs when the Data wire 402 transitions from high to low while the Clock wire 404 is high.

The bus master may transmit an initiator 422 that may be a START condition 406 or a repeated START 410 prior to transmitting an address of a slave, a command, and/or data. FIG. 4 illustrates a command code transmission 420 by the bus master. The initiator 422 may be followed in transmission by a predefined command 424 indicating that a command code 426 is to follow. The command code 426 may, for example, cause the serial bus to transition to a desired mode of operation. In some instances, data 428 may be transmitted. The command code transmission 420 may be followed by a terminator 430 that may be a STOP condition 408 or a repeated START 410.

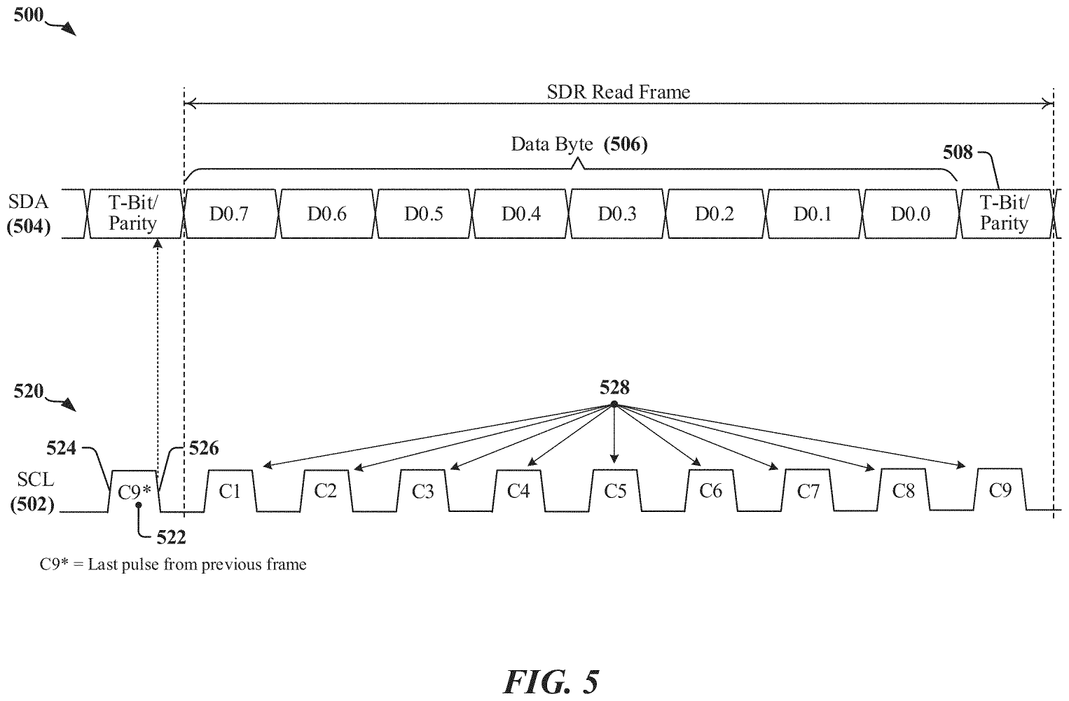

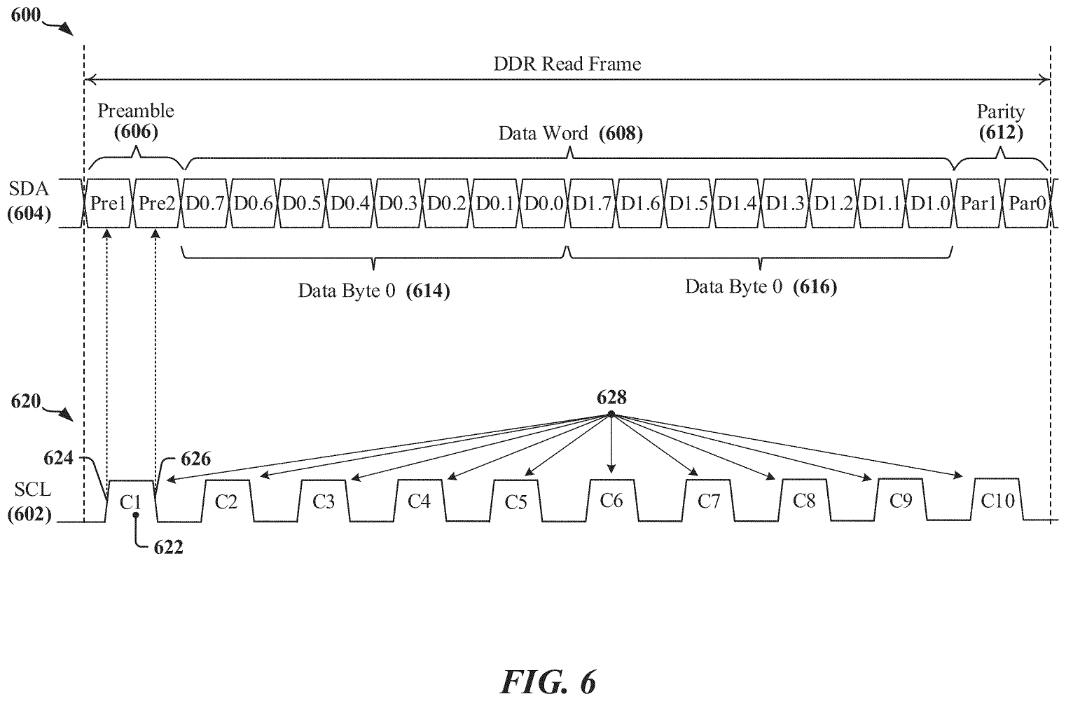

FIGS. 5 and 6 include timing diagrams that illustrate frames 500, 600 transmitted on a serial bus when a bus master device is reading from a slave device. The serial bus has a clock wire (SCL 502, 602) and a Data wire (SDA 504, 604). A clock signal 520, 620 transmitted on SCL 502, 602 provides timing may be usable when the serial bus is operated in an I3C single data rate (SDR) mode and in an I3C high data rate (HDR) double data rate (DDR) mode. The clock signal includes pulses 522, 528, 622, 628 that are defined by a rising edge 524, 624 and a falling edge 526, 626. A bus master device transmits the clock signal on the SCL 502, 602 regardless of the direction of flow of data over the serial bus.

FIG. 5 illustrates a frame 500 transmitted while the serial bus is operated in the I3C SDR mode. A single byte of data 506 is transmitted in each frame 500. The data signal transmitted on SDA 504 is expected to be stable for the duration of the high state of the pulses 528 in the clock signal 520 and, in one example, the state of SDA 504 is sampled on the falling edges of the clock pulses 528. Each byte of data 506 is followed by a bit 508 that can serve as a parity bit or a transition bit (T-Bit).

FIG. 6 illustrates a frame 600 transmitted while the serial bus is operated in the I3C HDR-DDR mode. In the I3C HDR-DDR mode, data is transferred at both the rising edge 624 and the falling edge 626 of a pulse 622 in the clock signal 620. A receiver samples or captures one bit of data on SDA 604 at each edge of the pulses 628 in the clock signal 620. A 2-byte data word 608 is transmitted in each frame 600 in the I3C HDR-DDR mode. A data word 608 generally includes 16 payload bits, organized as two 8-bit bytes 614, 61 and the data word 608 is preceded by a two-bit preamble 606 and followed by two parity bits 612. The 20 bits in the frame 600 can be transferred on the edges of 10 clock pulses. The integrity of the transmission may be protected by the transmission of the parity bits 612.

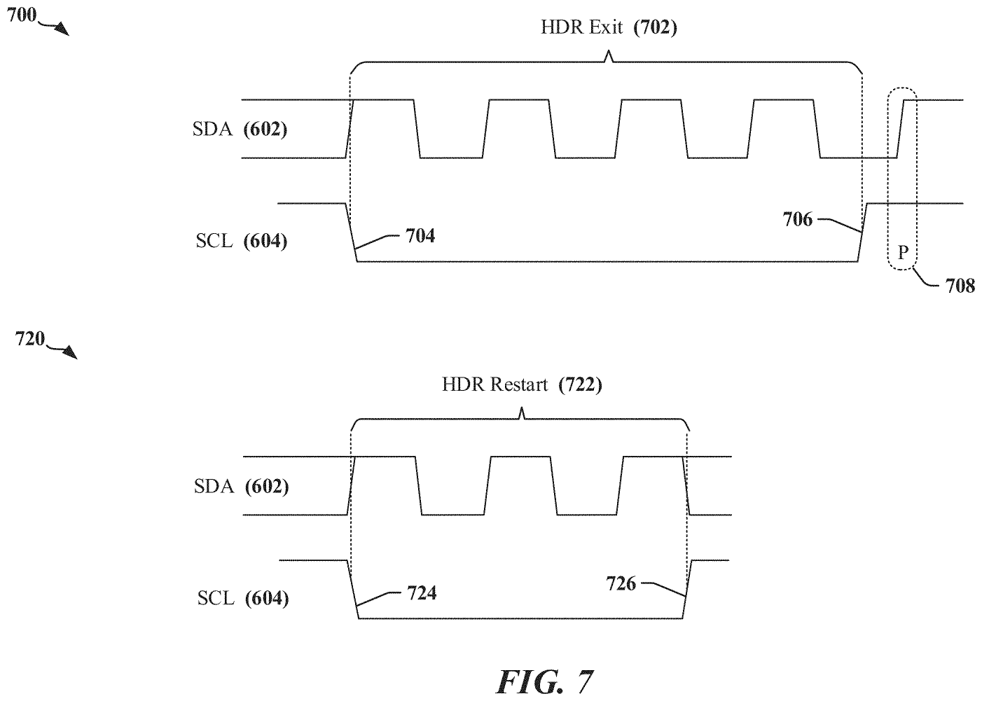

An I3C bus may be switched between I3C SDR and I3C DDR modes. FIG. 7 illustrates examples of signaling 700, 720 transmitted on SDA 604 and SCL 602 to initiate certain mode changes. The signaling 700, 720 is defined by I3C protocols for use in initiating restart, exit and/or break from I3C HDR modes of communication.

The first signaling 700 serves an HDR Exit 702 that may be used to cause an HDR break or exit. The HDR Exit 702 commences with a falling edge 704 on SCL 602 and ends with a rising edge 706 on SCL 602. While SCL 602 is in low signaling state, four pulses are transmitted on SDA 604. I2C devices ignore SDA 604 when no pulses are provided on SCL 602. A stop condition 708 may be transmitted to cause slave devices to reset their respective bus interfaces.

The second signaling 720 is an HDR Restart 722 that may be used to indicate a continuation of HDR transmission. The HDR Restart 722 commences with a falling edge 704 on SCL 602 and ends with a rising edge 706 on SCL 602, which confirms further HDR transmission. While SCL 602 is in low signaling state, three pulses are transmitted on SDA 604. I2C devices ignore SDA 604 when no pulses are provided on SCL 602.

### Multilane Serial Bus

Various examples discussed herein may be based on, or refer to a MIPI-defined I3C bus, operated in an SDR mode. The use of MIPI I3C SDR mode and other I3C mode is referenced as one example, and the principles disclosed herein are applicable in other examples and contexts.

In some aspects, enhanced capability and speed increases may be obtained by the addition of one or more supplementary lines, enabling a change in the coding base to higher numbers. For example, in addition to a two-wire bus, many I2C legacy systems use one or more dedicated interrupt lines between a master device and one or more slave devices. These dedicated interrupt lines may be repurposed for multi-lane operation in which data can be transmitted on two or more wires in accordance with timing provided by a clock signal transmitted on a clock wire. A two-line serial bus operated in an I3C SDR mode can be extended with one or more additional lines.

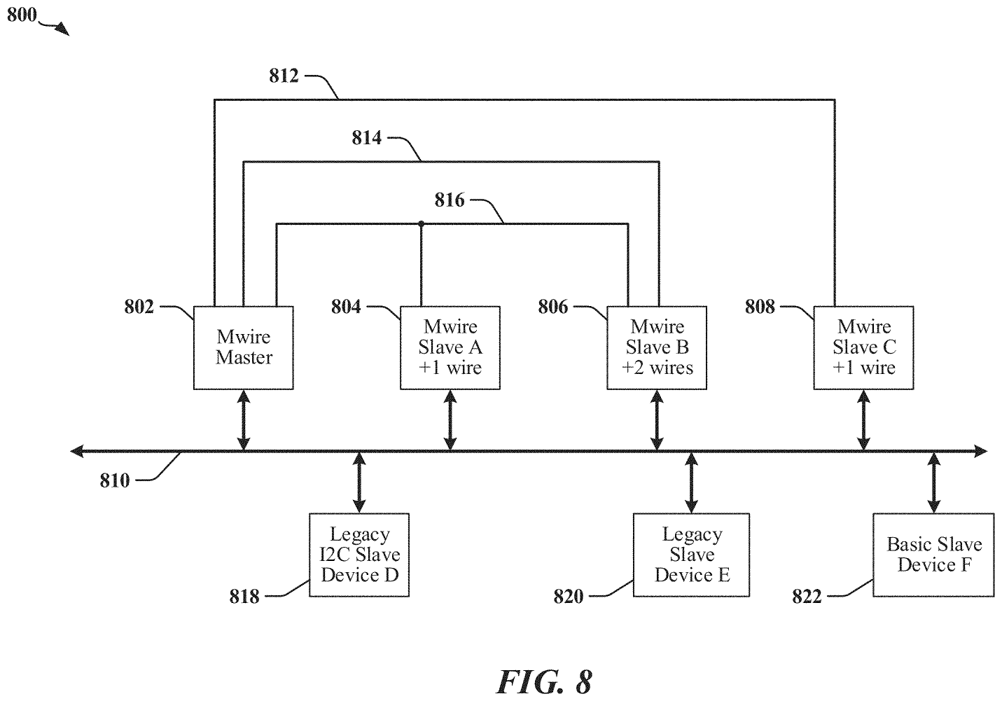

FIG. 8 illustrates a serial bus 800 in which more than two connectors or wires may be available for communication between devices 802, 804, 806, and/or 808. Devices 802, 804, 806, and/or 808 that can support communication over an expanded serial bus that includes additional wires may be referred to as multi-lane (Multilane) devices or multi-lane devices. Note that the terms “connector”, “wire” and “line” may be interchangeably used herein to refer to an electrically conductive path. In some instances, a “connector”, “wire”, and “line” may apply to an optically conductive path. In addition to the common lines 316, 318 of a 2-wire serial bus, additional connectors or wires 812, 814, and/or 816 may be employed to couple a Multilane master device 802 to one or more Multilane slave devices 804, 806, and/or 808 separately from the serial bus 810. In one example, one Multilane slave device 808 may be connected to the Multilane master device 802 using a single, dedicated additional connector or wire 812. In another example, one Multilane slave device 804 may be connected to the Multilane master device 802 using a single, shared additional connector or wire 816. In another example, one Multilane slave device 806 may be connected to the Multilane master device 802 using two or more dedicated and/or shared additional connectors or wires 814 and 816. The number, type and arrangement of additional connectors or wires 812, 814, and/or 816 can be selected to balance bandwidth and power consumption for communications between Multilane devices 802, 804, 806, and/or 808. In some instances, the additional connectors may include optical or other types of connectors.

According to certain aspects, any number of wires that is greater than two physical lines can be used in an I3C interface. A shared bus 810 may be a two-wire serial bus that includes the Clock line 316 and Data line 318 wires of FIG. 3, or SCL 502, 602 and SDA 504, 604 in FIGS. 5 and 6. The shared bus 810 may be used for communicating with legacy devices 818, 820 and/or I3C devices 822 that are not configured for multi-lane operation. Legacy devices 818, 820 may include I2C device 818, an I3C device 822, or another type of device that uses a two-wire protocol compatible with other devices 802, 804, 806, 808, 818, 820, 822 coupled to the shared bus 810.

Bus management messages may be included in shared bus management protocols implemented on the Multilane-capable bus client devices 802, 804, 806, and 808. Bus management messages may be transferred between Multilane-capable devices 802, 804, 806, and 808 using the shared bus 810. Bus management messages may include address arbitration commands and/or messages, commands and/or messages related to data transport mode entry and exit, commands and/or messages used in the exchange of configuration data including, for example, messages identifying supported protocols, number and allocation of available physical wires, and commands and/or messages that are to negotiate or select a mode of communications.

As illustrated in FIG. 8, different legacy client devices 818 and 820 and I3C devices 822 that have more basic signaling capabilities may be supported by the I3C interface. The devices 802, 804, 806, 808, 818, 820, 822 coupled to the shared bus 810 are compatible with at least one common mode of communication (e.g., predefined base protocol over the two-wire bus 810). In one example the predefined base protocol (e.g., lowest common denominator protocol), may support an I2C mode of communication. In this latter example, each of the devices 802, 804, 806, 808, 818, 820, 822 may be adapted to at least recognize start and stop conditions defined by the predefined base protocol.

Two or more devices 802, 804, 806, 808, 820, and/or 822 may communicate using a second protocol (e.g., I3C SDR, I3C HDR-DDR, I3C HDR-Ternary, etc.) that is not supported by some of the other devices coupled to the shared bus 810. The two or more devices 802, 804, 806, 808, 818, 820, 822 may identify capabilities of the other devices using the predefined base protocol (e.g., an I2C protocol), after an I3C exchange is initiated, and/or through signaling on one or more additional connectors or wires 812, 814 and/or 816. In at least some instances, the configuration of devices coupled to the shared bus 810 may be predefined in the devices 802, 804, 806, 808, 818, 820, 822.

The additional connectors or wires 812, 814 and/or 816 may include multipurpose, reconfigurable connectors, wires, or lines that connect two or more of the Multilane devices 802, 804, 806, 808. The additional connectors or wires 812, 814 and/or 816 may include repurposed connections that may otherwise provide inter-processor communications capabilities including, for example interrupts, messaging and/or communications related to events. In some instances, the additional connectors or wires 812, 814 and/or 816 may be provided by design. In one example, the predefined base protocol may utilize the additional connectors or wires 812, 814 and/or 816 for sending interrupts from the slave devices to the master device. In the second protocol, the additional connectors or wires 812, 814 and/or 816 may be repurposed to transmit data in combination with the two-wire bus. The term “data lane” may be used herein to refer to a data line or wire used to communicate data when a device can support multiple data lines or wires (multiple data lanes).

Master and Slave roles are typically interchangeable between devices 802, 804, 806, 808, and FIG. 8 relates to a single interaction between two or more of the devices 802, 804, 806, 808, and/or 822. As illustrated, the current master device 802 can support extended communication capabilities with the other devices 804, 806, 808, using a combination of the additional connectors or wires 812, 814, and 816. The master device 802 is connected to two slave devices 804 and 808 using a single additional connector or wire 816 and 812, respectively. The master device 802 is connected to one slave device 806 using a pair of additional wires 814 and 816. Accordingly, the master device 802 may be configured to select a number of wires for communication based on the capabilities of all slave devices 804, 806, and/or 808 that are involved in a transaction. For example, the master device 802 may send data to the first slave device B 806 using the two-wire bus 810 plus both repurposed wires 814 and 816. Additionally, the master device 802 may send data to the second slave device A 804 using the two-wire bus 810 plus a first repurposed wire 816.

Data transmitted between two or more Multilane-capable devices 802, 804, 806, and/or 808 may be encoded using an adapted encoding scheme. One aspect provides for using the two-wire bus 810 and one or additional connectors or wires 812, 814, and/or 816 may be used to transmit data using all data wires for I3C SDR and I3C HDR-DDR modes.

According to certain aspects disclosed herein, a multilane extension of an I3C bus may be implemented to provide increased data throughput, while keeping the I3C Interface bus management procedures. In one example, I3C frame settings may be preserved to maintain the position of control information in frames that carry data during read and write operations. The content and operation of the control information may be defined by standards-defined protocols specified by standards bodies, industry associations and the like. The content and operation of the control information may be defined by proprietary protocols that, in some instances, may coexist or be compatible with standards-defined protocols. In some implementations, control information may include break points, preambles, T-bits, parity, and/or ACK/NACK signaling that can be transmitted within frame structures used by conventional two-wire buses operated in accordance with the standards-defined protocols or proprietary protocols.

In the examples illustrated by FIGS. 8-11, control information may be transmitted over a multi-wire bus in control bit fields defined by a protocol governing operation of the serial bus during a transaction. The control bit fields are defined for each frame transmitted during the transaction. In one example, the protocol governing operation of the serial bus during a transaction is defined by I3C specifications, where information is transmitted over the primary data lane is consistent with control bit field usage defined by I3C specifications for a two-wire bus. In accordance with certain aspects disclosed herein, certain bits in one or more control bit fields may be repurposed and/or new meaning may be defined for previously unused bits in one or more control bit fields. The bit fields may be configured such that a conventional one-lane slave device (coupled to two wires of the multi-lane serial bus) detects no difference in frame structure. In other examples, control information is transmitted over a multi-lane bus in control bit fields defined by proprietary specifications or protocols. In these examples, certain bits in the control bit fields may be repurposed and/or new meaning may be defined for previously unused bits in accordance with certain aspects disclosed herein.

The disclosure may employ certain examples involving a serial bus operated based on I3C specifications or protocols, although the concepts described can be applied to equally to a serial bus operated based on proprietary I3C specifications or protocols and/or specifications or protocols derived from conventional I3C specifications or protocols. The examples include implementations where control information is transmitted on a multi-wire serial bus that supports a multilane version of I3C protocols, and which may permit devices with single, dual or quad data lane communication capability to be connected using at least the same two-wire base lanes. Multilane-capable devices can be enabled a priori, with available data lanes enabled or supported.

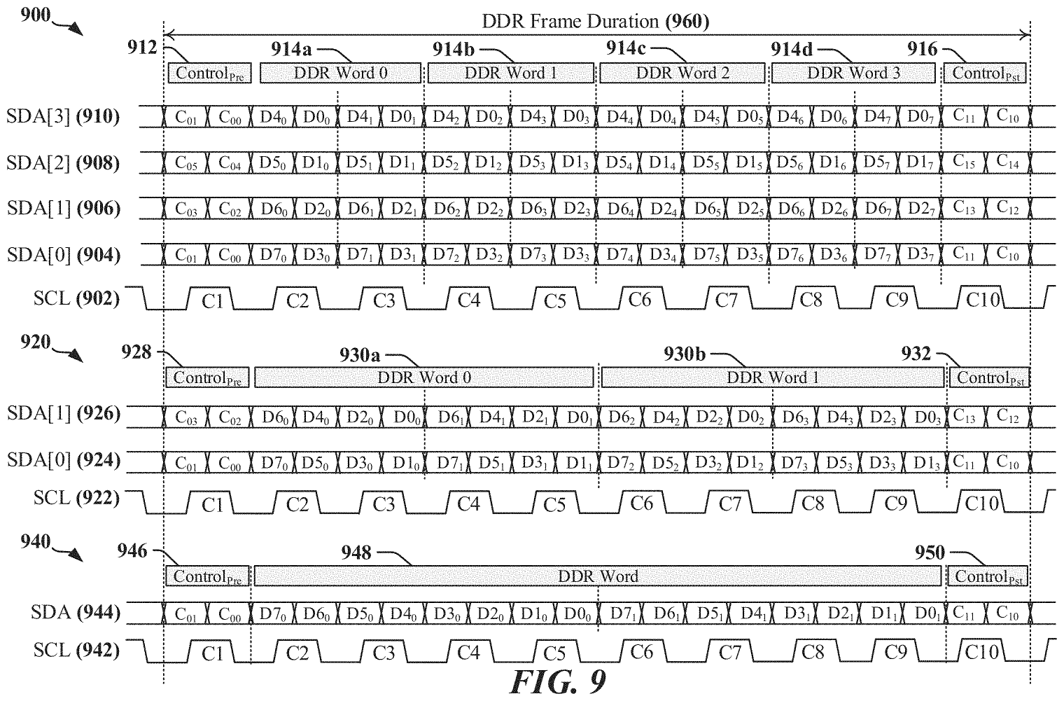

Certain aspects of data frames that can be transmitted over a multilane serial bus that may be adapted in accordance with certain aspects of this disclosure are illustrated in FIG. 9, which provides examples 900, 920, 940 of transmissions of data over a serial bus operated in an DDR mode when two or more devices can be coupled to additional connectors, lines or wires. The examples 900, 920, 940 relate to frames exchanged between slave and bus master devices when the serial bus is operated in accordance with I3C HDR-DDR protocols. In each example, 900, 920, 940 a common transaction and/or frame duration 960 is maintained regardless of the number of additional wires used. In one example 920, a transaction that involves the use of 2 data wires (SDA [0] 924, SDA[1] 926) and one clock wire 922 (SCL 942) can communicate twice as many bits as a transaction in the example 940 that uses 1 data wire (SDA 944) and one clock wire (SCL 942). The additional bits may include payload data bits, control or other protocol-defined bits and/or other information. Certain control bit fields 912, 928, 946 may be transmitted at the beginning of the frame, while other control bit fields 916, 932, 950 may be transmitted at the end of the frame. In accordance with certain aspects of this disclosure, control bit fields 912, 916, 928, 932, 946, 950 may be repurposed to enhance bus efficiency, coordinate or synchronize devices coupled to the serial bus, including signaling changes in modes of operation for example. In some instances, parity bits may be concurrently transmitted on one or more wires with a single clock pulse. The maintenance of a common transaction and/or frame duration 960 can provide a constant separation between break points and/or preambles 912, and devices coupled to the bus and configured for a conventional two-wire mode of operation remain unaware of the use of additional wires. The common transaction and/or frame duration 960 may effectively define a cadence for bus operations.

In a first example 940, no additional wires are used and communication proceeds using two wires (SCL 942 and SDA 944). A serialized data word 948 may be transmitted on SDA 944 after a control bit field 946. A control bit field 950 may be transmitted on SDA 944 after the data word 948. In a second example 920, one additional wire is used and communication proceeds using three wires (SCL 922, SDA[0] 924 and SDA[1] 926). Two data words 930a, 930b may be transmitted using SDA[0] 924 and SDA[1] 926 after control bit fields 928 have been transmitted on each of SDA[0] 924 and SDA[1] 926. Control bit fields 932 may be transmitted on SDA[0] 924 and SDA[1] 926 after the data words 930a, 930b. In the example, the data words 930a, 930b are transmitted in a striped mode, whereby a first data word 930a is completely transmitted in two-bit nibbles on the two data wires before the second data word 930b is transmitted.

In a third example 900, three additional wires are used and communication proceeds using five wires (SCL 902, SDA[0] 904, SDA[1] 906, SDA[2] 908 and SDA[3] 910). Four data words 914a, 914b, 914c and 914d may be transmitted using SDA[0] 904, SDA[1] 906, SDA[2] 908 and SDA[3] 910 after control bit fields 912 have been transmitted on each of SDA[0] 904, SDA[1] 906, SDA[2] 908 and SDA[3] 910. Control bit fields 916 may be transmitted on SDA[0] 904, SDA[1] 906, SDA[2] 908 and SDA[3] 910 after the data words the data words 914a, 914b, 914c and 914d. In the illustrated example, the data words 914a, 914b, 914c and 914d are transmitted in a striped mode, whereby a first data word 914a is completely transmitted in two-bit nibbles on the two data wires before the second data word 914b is transmitted, and so on. In each of the examples 900, 920, 940 in FIG. 9, data is clocked on both edges of each clock pulse in the clock signal, in accordance with I3C DDR protocols.

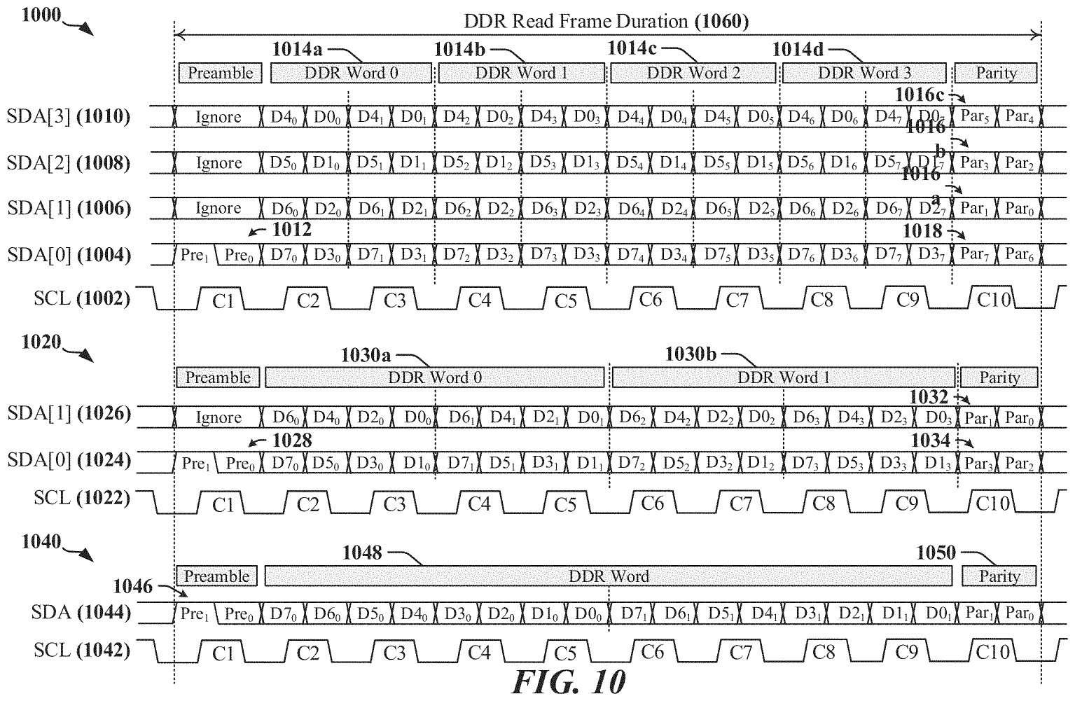

FIG. 10 illustrates read operations on a multilane serial bus that may be adapted in accordance with certain aspects of this disclosure. FIG. 10 provides examples 1000, 1020, 1040 of transmissions of data over a serial bus operated in an I3C HDR-DDR mode when two or more devices can be coupled to additional connectors, lines or wires. The examples 1000, 1020, 1040 relate to transmissions of read frames transmitted when a slave device is read by a bus master device in accordance with I3C protocols. In each example, 1000, 1020, 1040 a common transaction and/or frame duration 1060 is maintained regardless of the number of additional wires used. In one example 1020, a transaction that involves the use of 2 data wires (SDA [0] 1024, SDA[1] 1026) and one clock wire 1022 (SCL 1042) can communicate twice as many bits as a transaction in the example 1040 that uses 1 data wire (SDA 1044) and one clock wire (SCL 1042). The additional bits may include payload data bits, parity bits, other protocol-defined bits and/or other information. In some instances, a parity bit may be transmitted on each wire concurrently with a single clock pulse. The maintenance of a common transaction and/or frame duration 1060 can provide a constant separation between break points and/or preambles 1012, and devices coupled to the bus and configured for a conventional two-wire mode of operation remain unaware of the use of additional wires. The common transaction and/or frame duration 1060 may effectively define a cadence for bus operations.

In a first example 1040, no additional wires are used and communication proceeds using two wires (SCL 1042 and SDA 1044). A serialized data word 1048 may be transmitted on SDA 1044 after a two-bit preamble 1046. A two-bit parity field 1050 may be transmitted on SDA 1044 after the data word 1048. In a second example 1020, one additional wire is used and communication proceeds using three wires (SCL 1022, SDA[0] 1024 and SDA[1] 1026). Two data words 1030a, 1030b may be transmitted using SDA[0] 1024 and SDA[1] 1026 after a preamble 1028, which is a two-bit transmission on SDA[0] 1024. Two-bit parity fields 1032, 1034 are transmitted on SDA[0] 1024 and SDA[1] 1026 after the data words 1030a, 1030b and provide parity bits for the first-transmitted data word 1030a and the second-transmitted data word 1030b, respectively. In one example, the parity fields 1032, 1034 provide a parity bit for each byte of a respective data word 1030a, 1030b. In the example, the data words 1030a, 1030b are transmitted in a striped mode, whereby a first data word 1030a is completely transmitted in two-bit nibbles on the two data wires before the second data word 1030b is transmitted.

In a third example 1000, three additional wires are used and communication proceeds using five wires (SCL 1002, SDA[0] 1004, SDA[1] 1006, SDA[2] 1008 and SDA[3] 1010). Four data words 1014a, 1014b, 1014c and 1014d may be transmitted using SDA[0] 1004, SDA[1] 1006, SDA[2] 1008 and SDA[3] 1010 after a preamble 1012, which is a two-bit transmission on SDA[0] 1004. Two-bit parity fields 1016a, 1016b, 1016c are transmitted on SDA[1] 1006, SDA[2] 1008 and SDA[3] 1010 after the data words 1014a, 1014b, 1014c and 1014d and provide parity bits for the first-transmitted data word 1014a, the second-transmitted data word 1014b and the third-transmitted data word 1014c, respectively. A two-bit parity field 1018 for the fourth-transmitted data word 1014d is transmitted on SDA[0] 1014. In one example, the parity fields 1016a, 1016b, 1016c, 1018 provide a parity bit for each byte of a respective data word 1014a, 1014b, 1014c and 1014d. In the example, the data words 1014a, 1014b, 1014c and 1014d are transmitted in a striped mode, whereby a first data word 1014a is completely transmitted in two-bit nibbles on the two data wires before the second data word 1014b is transmitted, and so on.

In the multilane examples 1000, 1020, parity fields 1018, 1034 for the last-transmitted data word 1014d, 1030b are transmitted on SDA[0] 1004, 1024. In each of the examples 1000, 1020, 1040 in FIG. 10, data is clocked on both edges of each clock pulse in the clock signal, in accordance with I3C DDR protocols.

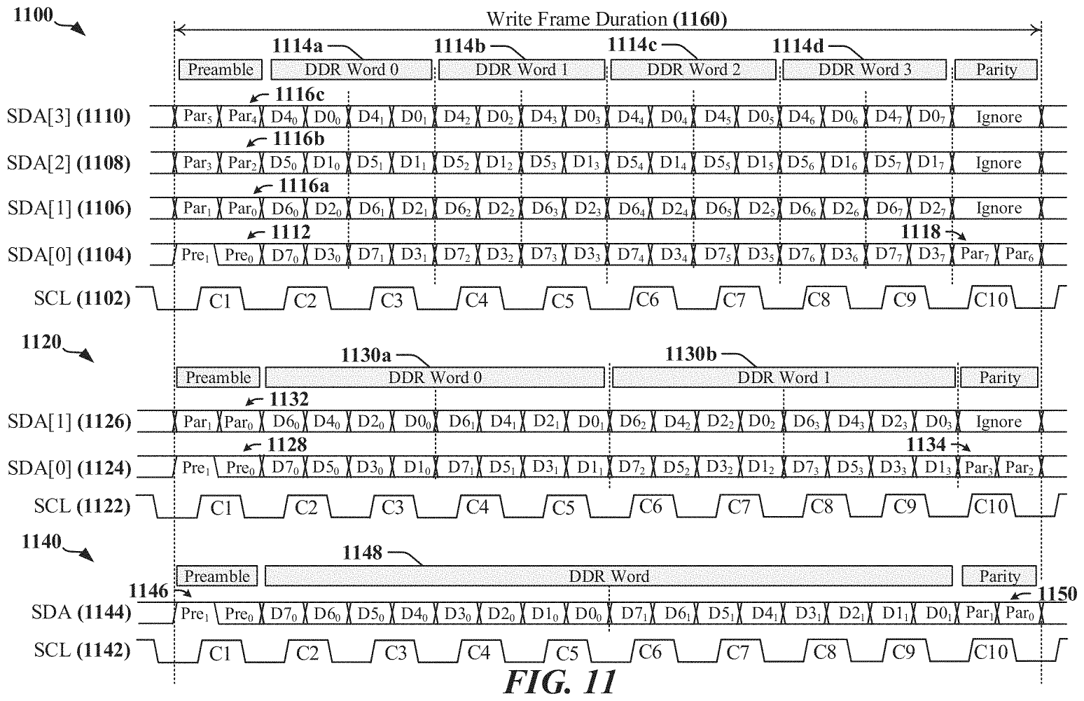

FIG. 11 illustrates write operations on a multilane serial bus that may be adapted in accordance with certain aspects of this disclosure. FIG. 11 provides examples 1100, 1120, 1140 of transmissions of data over a serial bus operated in an I3C HDR-DDR mode when two or more devices can be coupled to additional connectors, lines or wires. The examples 1100, 1120, 1140 relate to transmissions of write frames transmitted when a slave device is written by a bus master device in accordance with I3C HDR-DDR protocols. In each example, 1100, 1120, 1140 a common transaction and/or frame duration 1160 is maintained regardless of the number of additional wires used. In one example 1120, a transaction that involves the use of 2 data wires (SDA [0] 1124, SDA [1] 1126) and one clock wire 1122 (SCL 1142) can communicate twice as many bits as a transaction in the example 1140 that uses 1 data wire (SDA 1144) and one clock wire (SCL 1142). The additional bits may include payload data bits, parity bits, other protocol-defined bits and/or other information. In some instances, a parity bit may be transmitted on each wire concurrently with a single clock pulse. The maintenance of a common transaction and/or frame duration 1160 can provide a constant separation between break points and/or preambles 1112. Devices coupled to the bus and configured for a conventional two-wire mode of operation remain unaware of the use of additional wires. The common transaction and/or frame duration 1160 may effectively define a cadence for bus operations.

In a first example 1140, no additional wires are used and communication proceeds using two wires (SCL 1142 and SDA 1144). A serialized data word 1148 may be transmitted on SDA 1144 after a two-bit preamble 1146. A two-bit parity field 1150 may be transmitted on SDA 1144 after the data word 1148. In a second example 1120, one additional wire is used and communication proceeds using three wires (SCL 1122, SDA[0] 1124 and SDA[1] 1126). Two DDR data words 1130a, 1130b may be transmitted using SDA[0] 1124 and SDA[1] 1126 after a preamble 1128, which is a two-bit transmission on SDA[0] 1124. A two-bit parity field 1132 is transmitted on SDA[1] 1126 concurrently with the preamble 1128 and provides parity bits for the first-transmitted DDR data word 1130a. A two-bit parity field 1134 is transmitted on SDA[0] 1124 after the data words 1130a, 1130b and provides parity bits for the second-transmitted DDR data word 1130b. In one example, the parity fields 1132, 1134 provide a parity bit for each byte of a respective DDR data word 1130a, 1130b. In the example, the data words 1130a, 1130b are transmitted in a striped mode, whereby a first data word 1130a is completely transmitted in two-bit nibbles on the two data wires before the second data word 1130b is transmitted.

In a third example 1100, three additional wires are used and communication proceeds using five wires (SCL 1102, SDA[0] 1104, SDA[1] 1106, SDA[2] 1108 and SDA[3] 1110). Four data words 1114a, 1114b, 1114c and 1114d may be transmitted using SDA[1] 1106, SDA[2] 1108 and SDA[3] 1110 after a preamble 1112, which is a two-bit transmission on SDA[0] 1104. Two-bit parity fields 1116a, 1116b, 1116c are transmitted on SDA[1] 1106, SDA[2] 1108 and SDA[3] 1110 concurrently with the preamble 1112 to provide parity bits for the first-transmitted data words 1114a, 1114b, 1114c. A two-bit parity field 1118 is are transmitted on SDA[0] after the data words 1114a, 1114b, to provide parity bits for the last-transmitted data word 1114d. In one example, the parity fields 1116a, 1116b, 1116c, 1118 provide a parity bit for each byte of a respective data word 1114a, 1114b, 1114c and 1114d. In the example, the data words 1114a, 1114b, 1114c and 1114d are transmitted in a striped mode, whereby a first data word 1114a is completely transmitted in two-bit nibbles on the two data wires before the second data word 1114b is transmitted, and so on.

In the multilane examples 1100, 1120, parity fields 1118, 1134 for the last-transmitted data word 1114d, 1130b are transmitted on SDA[0] 1104, 1124. In each of the examples 1100, 1120, 1140 in FIG. 11, data is clocked on both edges of each clock pulse in the clock signal, in accordance with I3C DDR protocols.

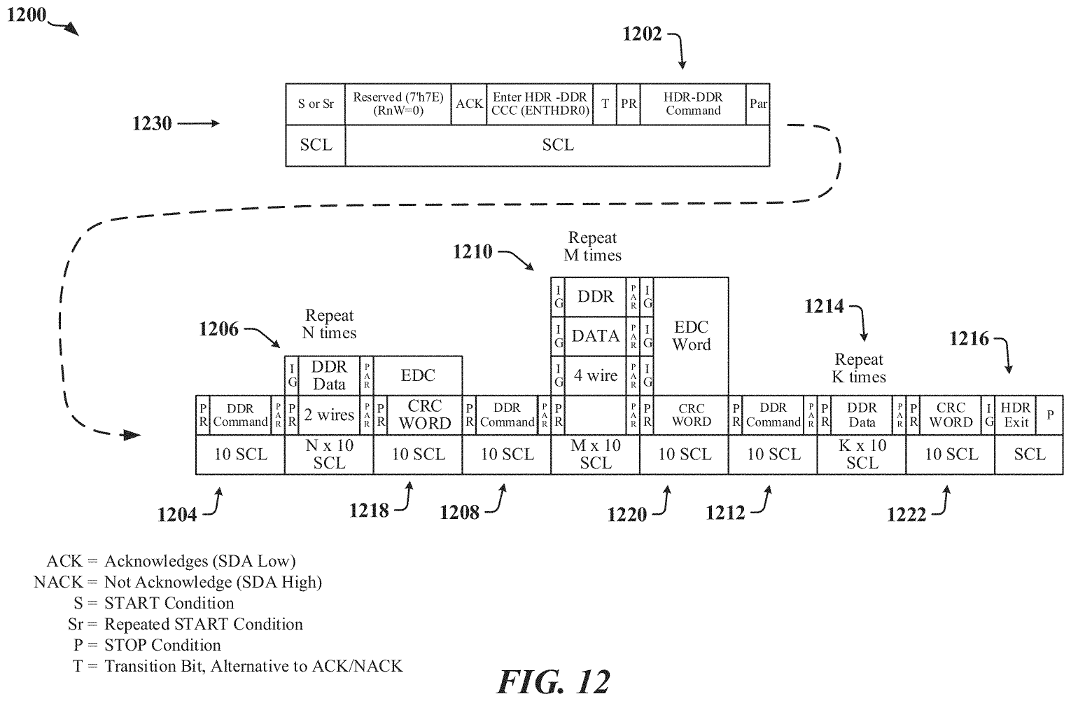

According to certain aspects, a multilane serial bus may be dynamically switched between modes of operation and may select a number of data lanes, or symbol bit-size for use in transmissions between multilane-enabled devices. FIG. 12 is an example of a timeline 1200 illustrating the operation of a multilane-enabled serial bus. The serial bus may initially be configured for a mode of operation supported by all devices coupled to the serial bus. In one example, all devices coupled to the serial bus may support an I3C SDR mode.

An initial transmission 1230, that includes a first command 1202 may be initiated in the I3C SDR mode. In one example, the first command 1202 includes a common command code (CCC) that causes one or more devices coupled to the serial bus to be operated in HDR-DDR mode. A second command 1204 is transmitted in HDR-DDR mode to select a bus width and other parameters for a first transaction 1206 to be executed in the HDR-DDR mode. In the illustrated example, the second command 1204 causes data to be transmitted over the serial bus and one additional wire. The first transaction 1206 may include transmission of a number (N) of 16-bit data words followed by a CRC word 1218. In some instances, the one or more devices may remain in the HDR-DDR mode and/or may continue to use the selected bus width until one or more new commands are transmitted that cause the one or more devices to modify mode of operation and/or bus width.

In some implementations, the number of wires used by devices may be preconfigured during manufacture, assembly and/or system configuration. In at least some instances, commands may be transmitted to modify preconfigured definitions of bus width and other parameters related to bus and/or device configuration. When the bus configuration parameters are preconfigured, the commands 1204, 1208 and 1212 need not specify the parameters for each transaction because the addressed devices can automatically configure their bus interfaces. In some instances, commands transmitted for multilane operations can be identical to commands transmitted for base operations that use only SCL and SDA (or SDA[0]). A device coupled to the serial bus may be configured to respond to the commands based on preconfigured bus configuration information.

A third command 1208 is transmitted in HDR-DDR mode to select a bus width and other parameters for a second transaction 1210 to be executed in the HDR-DDR mode. In the illustrated example, the third command 1208 causes data to be transmitted over the serial bus and three additional wires. The second transaction 1210 may include transmission of a number (M) of 16-bit data words followed by a CRC word 1220. A fourth command 1212 is transmitted in HDR-DDR mode to select a bus width and other parameters for a third transaction 1214 to be executed in the HDR-DDR mode. In the illustrated example, the fourth command 1212 causes data to be transmitted over the serial bus and no additional wires. The third transaction 1214 may include transmission of a number (K) of 16-bit data words followed by a CRC word 1222.

According to certain aspects disclosed herein, unused bits in a frame may be used to indicate early termination of the frame. Early termination may be indicated when there are insufficient data words available to fill the frame. Useful data is not conventionally transmitted in data bit slots on additional wires during transmission of the preamble 1012, 1028 in a full read frame (see FIG. 10), or during the final clock pulse (C10) of a full write frame (see FIG. 11). In accordance with certain aspects disclosed herein, unused bit fields may be used to signal the presence of padding and, in some instances, to indicate that the frame is being terminated early.

According to certain aspects, a CRC word 1218, 1220, 1222 is transmitted after the last frame in a transaction regardless of whether the last frame is filled with valid data, includes padding data, or is terminated early. The transmission of a CRC word CRC word 1218, 1220, 1222 can reinforce or confirm dummy bytes are intentionally transmitted, or that an early-terminated data block is being intentionally terminated early.

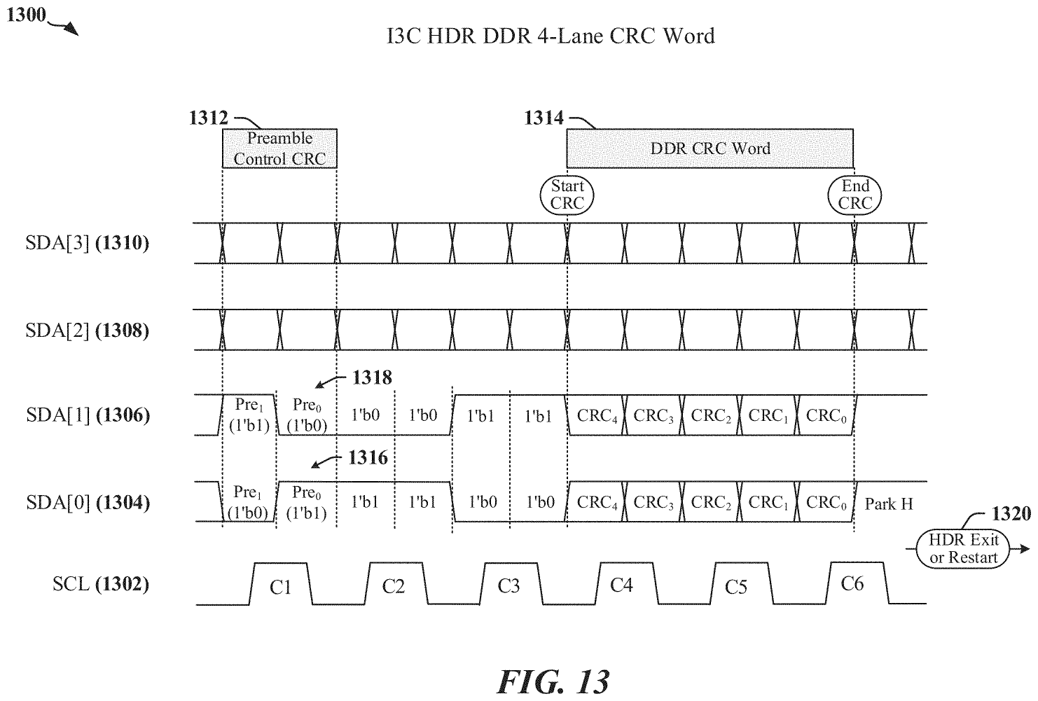

FIG. 13 illustrates an example of a final frame 1300 in which a CRC word 1314 is transmitted at the end of a multilane write. The transmission of the CRC word 1314 is signaled by the content of bits 1316, 1318 transmitted in the preamble 1312. The CRC word 1314 is transmitted after the last data frame in a transaction, including last data frames that are filled with valid data and last data frames that include padding in one or more words. According to certain aspects of the disclosure, the CRC word 1314 is transmitted when the last data frame is terminated early. According to certain aspects disclosed herein, the preamble 1312 may be used to encode certain characteristics of the last frame of a transaction, including the number of valid words and/or whether the fast frame is to be terminated early. After transmission of the last frame, an HDR Exit 702 (see FIG. 7) or HDR Restart may be transmitted 1320 using SCL 1302 and SDA[0] 1304.

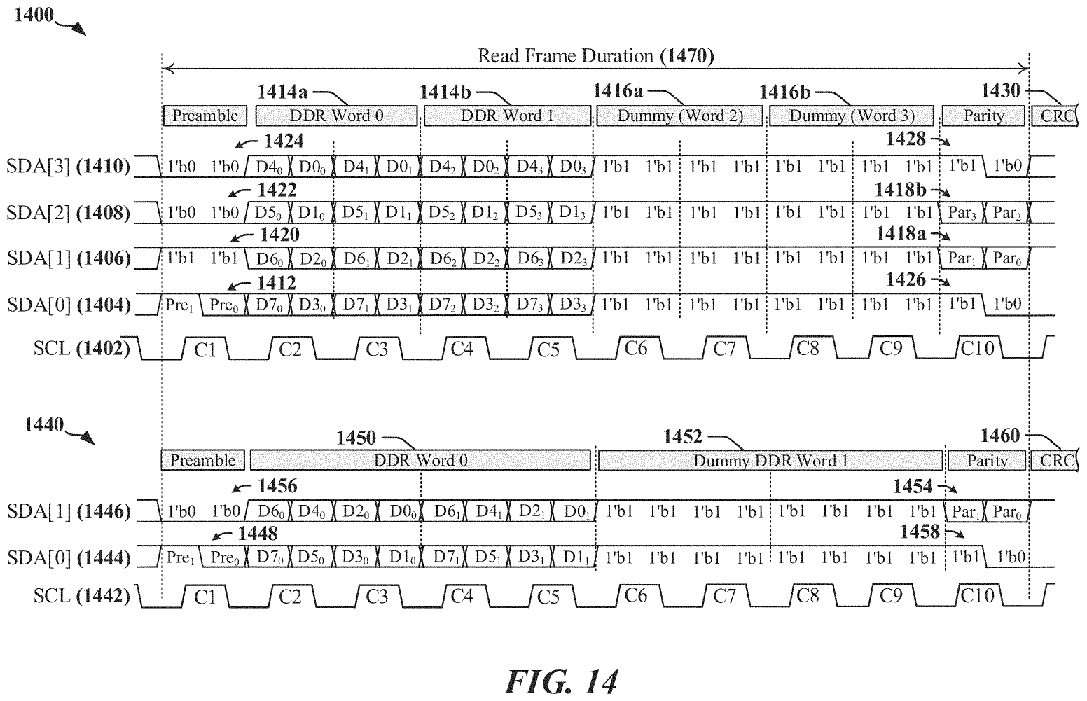

FIG. 14 illustrates examples 1400, 1440 in which padding may be used to maintain bus cadence when a serial bus is operated in accordance with an I3C HDR-DDR protocol. The examples 1400, 1440 relate to transmissions of read frames transmitted when a slave device is read by a bus master device in accordance with the I3C DDR protocol. In each example, 1400, 1440 a common transaction and/or frame duration 1470 is maintained, regardless of the number of words available for transmission.

In the first example 1440, one additional wire is used and communication proceeds using three wires (SCL 1442, SDA[0] 1444 and SDA[1] 1446). In this example 1440, one valid data word 1450 is transmitted followed by a second, dummy data word 1452 that is transmitted as padding to maintain the frame duration 1470. The words 1450, 1452 may be transmitted after a preamble 1448 is transmitted on SDA[0] 1424. A two-bit parity field 1454 for the valid data word 1450 is transmitted on SDA[1] 1446 after the dummy data word 1452 is transmitted.

According to certain aspects of this disclosure, a validity indicator 1456 is transmitted on SDA[1] 1446 concurrently with the preamble 1448, which is transmitted on SDA[0] 1444 in the first clock cycle of the frame. The value of the bits in the validity indicator 1456 indicate whether the second word includes valid data. In the illustrated example 1440, both bits are set to 1′b0 indicating that an invalid dummy data word 1452 is to be transmitted. No parity is transmitted on SDA[0] 1444 for the dummy data word 1452, and the corresponding bits can be used to carry control information. The frame is followed by transmission of a CRC word 1460.

In a second example 1400, three additional wires are used and communication proceeds using five wires (SCL 1402, SDA[0] 1404, SDA[0] 1406 and SDA[1] 1408). In this example 1400, two valid data words 1414a, 1414b are transmitted, followed by two dummy data words 1416a, 1416b, which are transmitted as padding to maintain the frame duration 1470. The data words 1414a, 1414b, 1416a, 1416b may be transmitted after a preamble 1412 is transmitted on SDA[0] 1404. Two-bit parity fields 1418a, 1418b for the valid data words 1416a, 1416b, respectively are transmitted on SDA[1] 1406 and SDA[2] 1408 after the last dummy data word 1416b has been transmitted. No parity is transmitted on SDA[3] 1410 or SDA[0] 1404 for the dummy data words 1416a, 1416b, respectively. The frame is followed by transmission of a CRC word 1430.

According to certain aspects of this disclosure, validity indicators 1420, 1422, 1424 may be transmitted on SDA[1] 1406, SDA[2] 1408, and SDA[3] 1410 concurrently with the preamble 1412, which is transmitted on SDA[0] 1404 in the first clock cycle of the frame. The value of the bits in the validity indicators 1420, 1422, 1424 indicate whether a corresponding word 1414b, 1416a, 1416b includes valid data. In the illustrated example 1400, both bits of a first validity indicator 1420 are set to 1′b1 indicating that the second word 1414b is valid. The bits of the other validity indicators 1422, 1424 are set to 1′b0 indicating that the last two data words 1416a, 1416b are invalid.

The common frame duration 1470 enables a consistent bus cadence to be defined and maintained on a multilane serial bus. A multilane serial bus can provide significant throughput advantages, particularly for large blocks of data transfers. Some efficiency may be lost when frames are transmitted without a full data payload when, for example, there is insufficient data available for transmission to fill all bytes transmitted in a frame. In such circumstances, the latter portion of a data payload in a frame carries no useful information and yet can consume a number of clock cycles, leading to increased latency and reduced throughput.

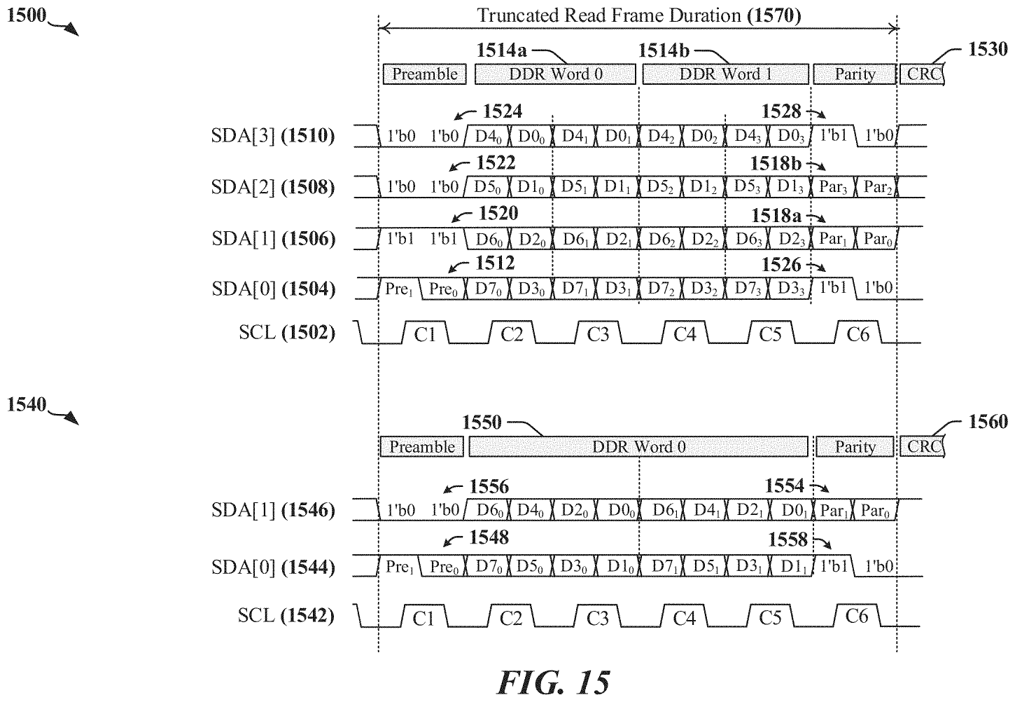

FIG. 15 illustrates examples 1500, 1540 in which frames may be terminated early in accordance with certain aspects disclosed herein. In the examples 1500, 1540, a multilane serial bus is operated in accordance with an I3C DDR protocol. The examples 1500, 1540 relate to transmissions of read frames transmitted when a slave device is read by a bus master device in accordance with the I3C DDR protocol. In each example 1500, 1540, transmission of the frame is terminated early resulting in a frame duration 1570 that is truncated with respect to the duration of transmission of a full frame. When a transmission is truncated, the final data word 1514b, 1550 may be followed by a CRC word 1530, 1560, an HDR Restart pattern and/or an HDR EXIT pattern. The examples 1500, 1540 in FIG. 15 illustrate the transmission of the CRC word 1530, 1560 for illustrative purposes only.

In the first example 1540, one additional wire is used and communication proceeds using three wires (SCL 1542, SDA[0] 1544 and SDA[1] 1546). In this example 1540, transmission is terminated after the sole valid data word 1550 is transmitted. The word 1550 may be transmitted after a preamble 1548 is transmitted on SDA[0] 1524. A two-bit parity field 1554 for the valid data word 1550 is transmitted on SDA[1] 1546 immediately after the valid data word 1550 is transmitted. The frame is followed by transmission of a CRC word 1560.

According to certain aspects of this disclosure, a validity indicator 1556 is transmitted on SDA[1] 1546 concurrently with the preamble 1548, which is transmitted on SDA[0] 1544 in the first clock cycle of the frame. The value of the bits in the validity indicator 1556 indicate whether a second word is to be transmitted. In the illustrated example 1540, both bits are set to 1′b0 indicating that, for example, insufficient data is available to transmit a second word. Provision is made in the protocol for transmission of parity on SDA[0] 1544 for a second data word when available and the corresponding parity bits can be used to carry control information when the second data word is not transmitted. Frame transmission is terminated after the valid data word 1550 has been transmitted.

In a second example 1500, three additional wires are used and communication proceeds using five wires (SCL 1502, SDA[0] 1504, SDA[0] 1506 and SDA[1] 1508). In this example 1500, two valid data words 1514a, 1514b are transmitted when each conventional frame is configured to carry 4 words. The valid data words 1514a, 1514b may be transmitted after a two-bit preamble 1512 is transmitted on SDA[0] 1504. Two-bit parity fields 1518a, 1518b for the valid data words 1514a, 1514b, respectively are transmitted on SDA[1] 1506 and SDA[2] 1508 after the last valid data word 1514b has been transmitted. The frame is followed by transmission of a CRC word 1530.

According to certain aspects of this disclosure, validity indicators 1520, 1522, 1524 may be transmitted on SDA[1] 1506, SDA[2] 1508, and SDA[3] 1510 concurrently with the preamble 1512, which is transmitted on SDA[0] 1504 in the first clock cycle of the frame. The value of the bits in the validity indicators 1520, 1522, 1524 indicate whether a corresponding data word includes valid data. In the illustrated example 1500, both bits of a first validity indicator 1520 are set to 1′b1 indicating that the second data word 1514b is valid. The bits of the other validity indicators 1522, 1524 are set to 1′b0 indicating that the last two data words are invalid. The value of the bits in the validity indicators 1520, 1522, 1524 indicate whether words are to be transmitted after the first data word 1514a. In this example 1500, transmission of the frame is terminated after the second data word 1514b has been transmitted. Provision is made in the protocol for transmission of parity on SDA[0] 1504 for a third data word when available, and for transmission of parity on SDA[3] 1510 for a fourth data word. The corresponding unused parity bits can be repurposed to carry control information when the third and fourth data words are not transmitted.

When all valid words and corresponding parity have been transmitted, transmission is terminated.

Padding may be provided with a predefined value. For example, certain I3C specifications define a dummy byte with a value of 0xFFFF and specify that associated parity bits produce an error when submitted to a parity checking circuit. In one example, the parity bits may be set to 2′b10. The use of a validity indicator can render the parity checking mechanism redundant or merely supplemental. In some instances, the I3C-specified dummy byte and incorrect parity may be used when padding is inserted in frames.

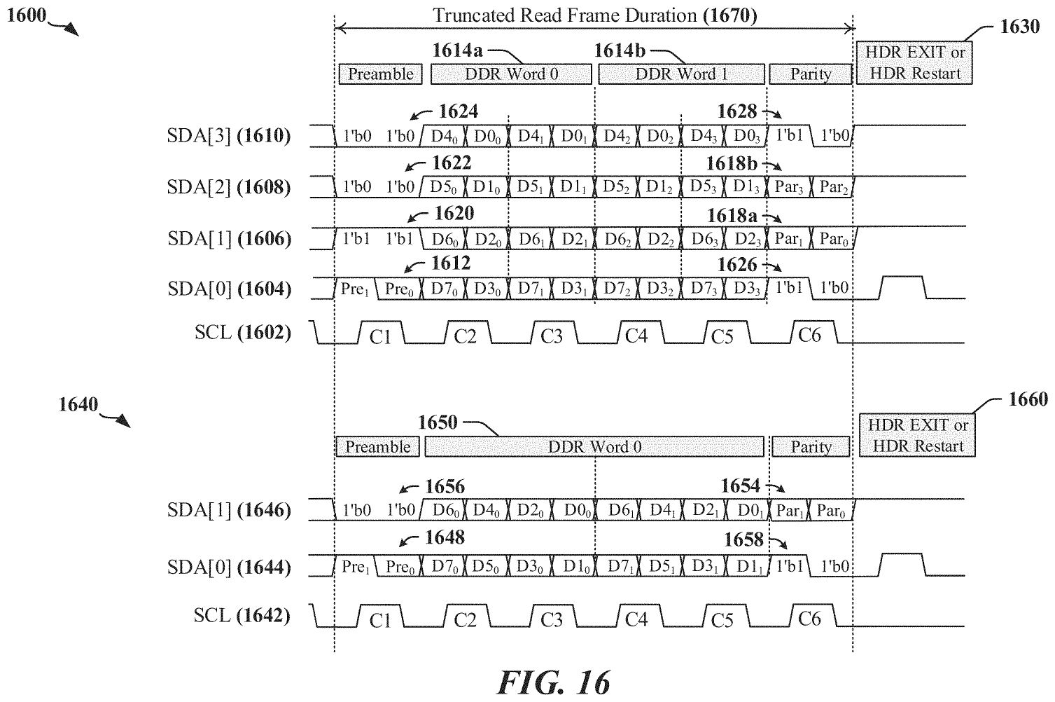

FIG. 16 illustrates examples 1600, 1640 in which frames may be terminated early in accordance with certain aspects disclosed herein. In the examples 1600, 1640, a multilane serial bus is operated in accordance with an I3C DDR protocol. The examples 1600, 1640 relate to transmissions of read frames transmitted when a slave device is read by a bus master device in accordance with the I3C DDR protocol. In each example 1600, 1640, transmission of the frame is terminated early resulting in a frame duration 1670 that is truncated with respect to the duration of transmission of a full frame. When a transmission is truncated, the final data word 1614b, 1650 may be followed by a CRC word and/or HDR Restart/Exit pattern 1630, 1660. The examples 1600, 1640 in FIG. 16 illustrate transmission of the HDR Restart/Exit pattern 1630, 1660 for illustrative purposes only.

In the first example 1640, one additional wire is used and communication proceeds using three wires (SCL 1642, SDA[0] 1644 and SDA[1] 1646). In this example 1640, transmission is terminated after the sole valid data word 1650 is transmitted. The word 1650 may be transmitted after a preamble 1648 is transmitted on SDA[0] 1624. A two-bit parity field 1654 for the valid data word 1650 is transmitted on SDA[1] 1646 immediately after the valid data word 1650 is transmitted. The frame is followed by transmission of the HDR Restart/Exit pattern 1660.

According to certain aspects of this disclosure, a validity indicator 1656 is transmitted on SDA[1] 1646 concurrently with the preamble 1648, which is transmitted on SDA[0] 1644 in the first clock cycle of the frame. The value of the bits in the validity indicator 1656 indicate whether a second word is to be transmitted. In the illustrated example 1640, both bits are set to 1′b0 indicating that, for example, insufficient data is available to transmit a second word. Provision is made in the protocol for transmission of parity on SDA[0] 1644 for a second data word when available and the corresponding parity bits can be used to carry control information when the second data word is not transmitted. Frame transmission is terminated after the valid data word 1650 has been transmitted.

In a second example 1600, three additional wires are used and communication proceeds using five wires (SCL 1602, SDA[0] 1604, SDA[0] 1606 and SDA[1] 1608). In this example 1600, two valid data words 1614a, 1614b are transmitted when each conventional frame is configured to carry 4 words. The valid data words 1614a, 1614b may be transmitted after a two-bit preamble 1612 is transmitted on SDA[0] 1604. Two-bit parity fields 1618a, 1618b for the valid data words 1614a, 1614b, respectively are transmitted on SDA[1] 1606 and SDA[2] 1608 after the last valid data word 1614b has been transmitted. The frame is followed by transmission of the HDR Restart/Exit pattern 1630.

According to certain aspects of this disclosure, validity indicators 1620, 1622, 1624 may be transmitted on SDA[1] 1606, SDA[2] 1608, and SDA[3] 1610 concurrently with the preamble 1612, which is transmitted on SDA[0] 1604 in the first clock cycle of the frame. The value of the bits in the validity indicators 1620, 1622, 1624 indicate whether a corresponding data word includes valid data. In the illustrated example 1600, both bits of a first validity indicator 1620 are set to 1′b1 indicating that the second data word 1614b is valid. The bits of the other validity indicators 1622, 1624 are set to 1′b0 indicating that the last two data words are invalid. The value of the bits in the validity indicators 1620, 1622, 1624 indicate whether words are to be transmitted after the first data word 1614a. In this example 1600, transmission of the frame is terminated after the second data word 1614b has been transmitted. Provision is made in the protocol for transmission of parity on SDA[0] 1604 for a third data word when available, and for transmission of parity on SDA[3] 1610 for a fourth data word. The corresponding unused parity bits can be repurposed to carry control information when the third and fourth data words are not transmitted.

When all valid words and corresponding parity have been transmitted, transmission is terminated.

Padding may be provided with a predefined value. For example, certain I3C specifications define a dummy byte with a value of 0xFFFF and specify that associated parity bits produce an error when submitted to a parity checking circuit. In one example, the parity bits may be set to 2′b10. The use of a validity indicator can render the parity checking mechanism redundant or merely supplemental. In some instances, the I3C-specified dummy byte and incorrect parity may be used when padding is inserted in frames.

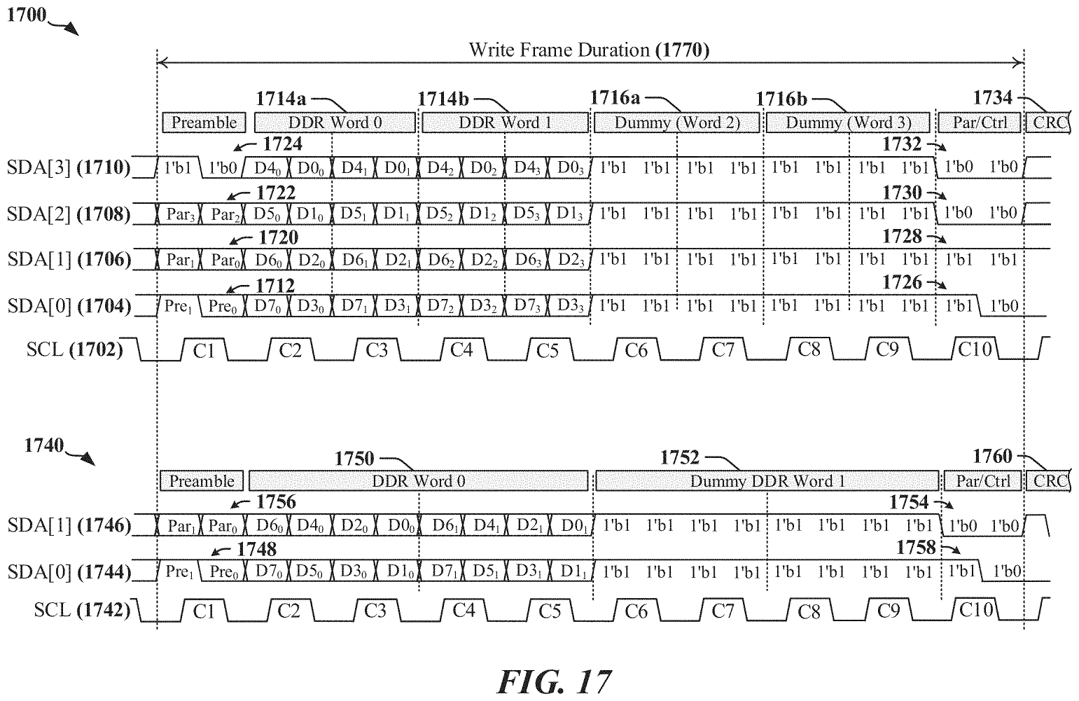

FIG. 17 illustrates examples 1700, 1740 in which padding may be used to maintain bus cadence when a serial bus is operated in accordance with an I3C HDR-DDR protocol. The examples 1700, 1740 relate to transmissions of write frames transmitted when a slave device is written by a bus master device in accordance with the I3C HDR-DDR protocol. In each example, 1700, 1740 a common transaction and/or frame duration 1770 is maintained, regardless of the number of words available for transmission. The final padding block (dummy data words 1716b, 1752) may be followed by a CRC word 1734, 1760, an HDR Restart pattern and/or an HDR EXIT pattern. The examples 1700, 1740 in FIG. 17 illustrate the transmission of the CRC word 1734, 1760 for illustrative purposes only.

In the first example 1740, one additional wire is used and communication proceeds using three wires (SCL 1742, SDA[0] 1744 and SDA[1] 1746). In this example 1740, one valid data word 1750 is transmitted followed by a second, dummy data word 1752 that is transmitted as padding to maintain the frame duration 1770. The words 1750, 1752 may be transmitted after a preamble 1748 is transmitted on SDA[0] 1724. A two-bit parity field 1756 for the valid data word 1750 is transmitted on SDA[1] 1746 concurrently with the data word 1752 is transmitted. The frame is followed by transmission of a CRC word 1760.

According to certain aspects of this disclosure, a validity indicator 1754 is transmitted on SDA[1] 1746 during the tenth clock cycle of the frame. The bits 1758 transmitted on SDA [0] 1744 during the tenth clock cycle of the frame are reserved for parity of the last word, which is a dummy word 1752 in this example 1740. The value of the bits in the validity indicator 1754 indicate whether the second word includes valid data. In the illustrated example 1740, both bits are set to 1′b0 indicating that an invalid dummy data word 1752 is being transmitted. No parity is needed for the dummy data word 1752, and the corresponding bits 1758 can be used to carry control information.

In a second example 1700, three additional wires are used and communication proceeds using five wires (SCL 1702, SDA[0] 1704, SDA[0] 1706 and SDA[1] 1708). In this example 1700, two valid data words 1714a, 1714b are transmitted, followed by two dummy data words 1716a, 1716b, which are transmitted as padding to maintain the frame duration 1770. The data words 1714a, 1714b, 1716a, 1716b may be transmitted after a preamble 1712 is transmitted on SDA[0] 1704. Two-bit fields 1720, 1722, 1724, 1726 are defined for parity. Three of the fields 1720, 1722, 1724 are transmitted on SDA[1] 1706, SDA[2] 1708, SDA[3] 1710 during the first clock cycle of the frame. The other field 1726 corresponds to the last-transmitted dummy data word 1716b and is transmitted on SDA[0] 1704 after the last dummy data word 1716b has been transmitted. The frame is followed by transmission of a CRC word 1734.

According to certain aspects of this disclosure, validity indicators 1728, 1730, 1732 may be transmitted on SDA[1] 1706, SDA[2] 1708, and SDA[3] 1710 during the last clock cycle of the frame. The value of the bits in the validity indicators 1728, 1730, 1732 indicate whether a corresponding word 1714b, 1716a, 1716b includes valid data. In the illustrated example 1700, both bits of a first validity indicator 1728 are set to 1′b1 indicating that the second word 1714b is valid. The bits of the other validity indicators 1730, 1732 are set to 1′b0 indicating that the last two data words (dummy data words 1716a, 1716b) are invalid.

The common frame duration 1770 enables a consistent bus cadence to be defined and maintained on a multilane serial bus. A multilane serial bus can provide significant throughput advantages, particularly for large blocks of data transfers. Some efficiency may be lost when frames are transmitted without a full data payload when, for example, there is insufficient data available for transmission to fill all bytes transmitted in a frame. In such circumstances, the latter portion of a data payload in a frame carries no useful information and yet can consume a number of clock cycles, leading to increased latency and reduced throughput.

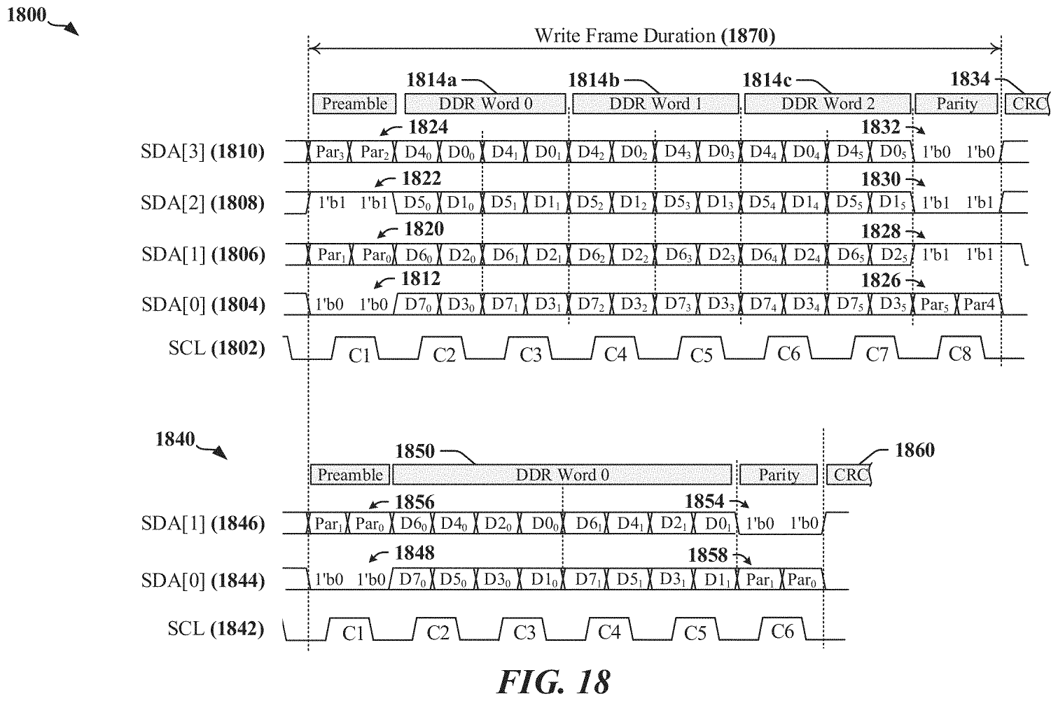

FIG. 18 illustrates examples 1800, 1840 in which frames may be terminated early in accordance with certain aspects disclosed herein. In the examples 1800, 1840, a multilane serial bus is operated in accordance with an I3C DDR protocol. The examples 1800, 1840 relate to transmissions of write frames transmitted when a slave device is written by a bus master device in accordance with the I3C DDR protocol. In each example 1800, 1840, transmission of the frame is terminated early resulting in a frame duration 1870 that is truncated with respect to the duration of transmission of a full frame. When a transmission is truncated, the final data word 1814c, 1850 may be followed by a CRC word 1834, 1860, an HDR Restart pattern and/or an HDR EXIT pattern. The examples 1800, 1840 in FIG. 18 illustrate the transmission of the CRC word 1834, 1860 for illustrative purposes only.

In the first example 1840, one additional wire is used and communication proceeds using three wires (SCL 1842, SDA[0] 1844 and SDA[1] 1846). In this example 1840, transmission is terminated after the sole valid data word 1850 is transmitted. The word 1850 may be transmitted after a preamble 1848 is transmitted on SDA[0] 1824. In this example, the preamble 1848 indicates that the current, last data frame is incomplete and includes only one of the two possible data words using a 2′b00 value for the preamble 1848. Here, both bits of the preamble 1848 are set to 1′b0 to indicate that the frame is the last frame and has only one valid word. A two-bit parity field 1856 for the valid data word 1850 is transmitted on SDA[1] 1846 concurrently with the preamble 1848. The parity for the valid data word 1850 is also transmitted on SDA[0] 1804 immediately after the data word 1850 is transmitted. The frame is followed by transmission of a CRC word 1860.

According to certain aspects of this disclosure, validity indicators are transmitted on SDA[1] 1846. In one example, a validity indicator 1854 is transmitted on SDA[1] 1846 immediately after the data word 1850 is transmitted. The value of the bits in the validity indicator 1854 indicate whether a second word is to be transmitted. In the illustrated example 1840, both bits are set to 1′b0 indicating that, for example, insufficient data is available to transmit a second word. Frame transmission is terminated after the valid data word 1850 and parity has been transmitted.

In a second example 1800, three additional wires are used and communication proceeds using five wires (SCL 1802, SDA[0] 1804, SDA[0] 1806 and SDA[1] 1808). In this example 1800, three valid data words 1814a, 1814b, 1814c are transmitted when each conventional frame is configured to carry 4 words. The data words 1814a, 1814b, 1814c may be transmitted after a two-bit preamble 1812 is transmitted on SDA[0] 1804. Here, both bits of the preamble 1812 are set to 1′b0 to indicate that the frame is the last frame, and that the frame is an incomplete frame. Two-bit parity fields 1820, 1824 for the first two data words 1814a, 1814b, respectively, are transmitted on SDA[1] 1806 and SDA[3] 1810 concurrently with the preamble 1812. A two-bit parity field 1826 for the final data word 1814c is transmitted on SDA[0] 1804 after the last valid data word 1814c has been transmitted. The frame is followed by transmission of a CRC word 1834.

According to certain aspects of this disclosure, validity indicators 1828, 1830, 1832 may be transmitted on SDA[1] 1806, SDA[2] 1808, and SDA[3] 1810 after the last valid data word 1814c has been transmitted. The value of the bits in the validity indicators 1828, 1830, 1832 indicate whether words are to be transmitted after the first data word 1814a. In the illustrated example 1800, both bits of two validity indicators 1828, 1830 are set to 1′b1 indicating that the second word 1814b and the third word 1814c are valid. The bits of the other validity indicator 1832 are set to 1′b0 indicating that the potential fourth data word is not being transmitted. In this example 1800, transmission of the frame is terminated after the third data word 1814c has been transmitted. The corresponding unused parity bits 1822 can be repurposed to carry control information when the fourth data word is not transmitted. In the illustrated example, the unused parity bits 1822 are repurposed to indicate the number of valid data words provided in the current frame carries, where the current frame is the last frame in the current transaction and is an incomplete frame. Here, the unused parity bits 1822 have a value set to 2b′11 (decimal 3) indicating that there are three valid data words in the incomplete frame.

According to certain aspects, the preamble 1812, 1848 transmitted before the last write frame of a transaction may have a value of 2′b00 when the last write data frame has less than the maximum number of data words and the last write data frame is terminated early. In the first example 1840, the preamble 1848 transmitted before the truncated last write data frame has a value of 2′b00 when the truncated last write data frame carries only one valid data word of the two possible data words per frame. In the second example 1800, the preamble 1812 transmitted before the truncated last write data frame has a value of 2′b00 since the truncated last write data frame carries three data words, one less than the four possible data words.

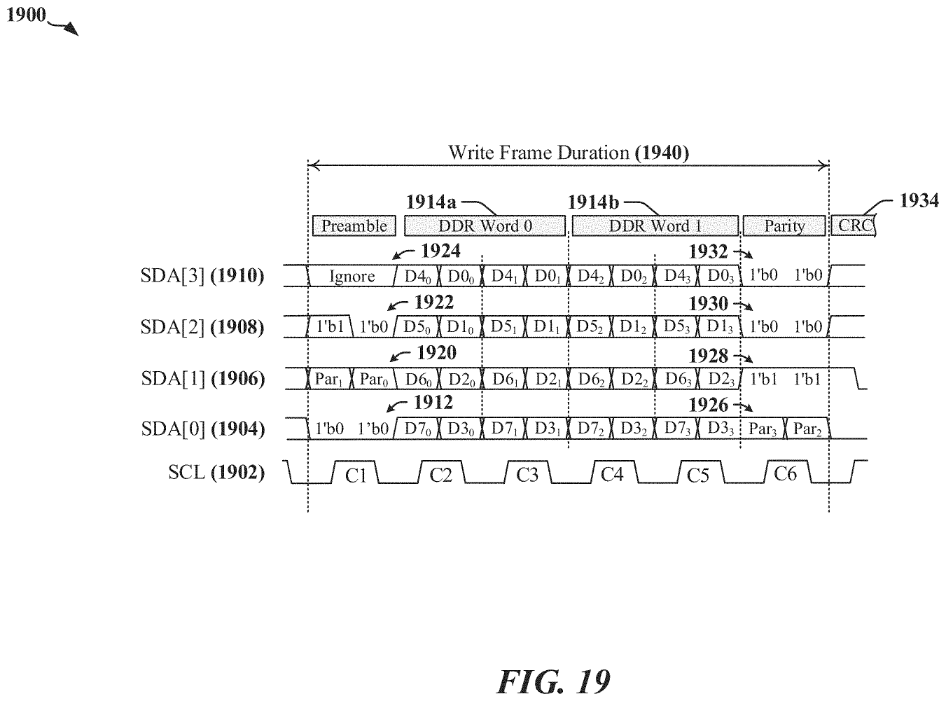

FIG. 19 illustrates an example 1900 in which a write frame may be terminated early in accordance with certain aspects disclosed herein. In the example 1900, a multilane serial bus is operated in accordance with an I3C DDR protocol. The example 1900 relates to transmissions of write frames transmitted when a slave device is written by a bus master device in accordance with the I3C DDR protocol. In the example 1900, transmission of the frame is terminated early resulting in a frame duration 1940 that is truncated with respect to the duration of transmission of a full frame. When a transmission is truncated, the final data word 1914b may be followed by a CRC word 1934, an HDR Restart pattern and/or an HDR EXIT pattern. The example 1900 in FIG. 19 illustrates the transmission of the CRC word 1934 for illustrative purposes only.

Three additional wires are used for transmission of the frame and communication proceeds using five wires (SCL 1902, SDA[0] 1904, SDA[0] 1906 and SDA[1] 1908). Two valid data words 1914a, 1914b are transmitted. The data words 1914a, 1914b may be transmitted after a two-bit preamble 1912 is transmitted on SDA[0] 1904. Here, both bits of the preamble 1912 are set to 1′b0 to indicate that the frame is the last frame in a transaction. A two-bit parity field 1920 for the first data word 1914a is transmitted on SDA[1] 1906 concurrently with the preamble 1912. A two-bit parity field 1926 for the final data word 1914b is transmitted on SDA[0] 1904 after the last valid data word 1914b has been transmitted. The frame is followed by transmission of a CRC word 1934.

According to certain aspects of this disclosure, validity indicators 1928, 1930, 1932 may be transmitted on SDA[1] 1906, SDA[2] 1908, and SDA[3] 1910 after the last valid data word 1914c has been transmitted. The value of the bits in the validity indicators 1928, 1930, 1932 indicate whether words are to be transmitted after the first data word 1914a. In the illustrated example 1900, both bits of one validity indicator 1928 is set to 1′b1 indicating that the second word 1914b is valid. The bits of the other validity indicators 1930, 1932 are set to 1′b0 indicating that potential third and fourth data words are not being transmitted. In this example 1900, transmission of the frame is terminated after the second data word 1914b has been transmitted. The corresponding unused parity bits 1922, 1924 can be repurposed to carry control information when the third and fourth data words are not transmitted. In the illustrated example, the unused parity bits 1922 are repurposed to indicate the number of valid data words provided in the current frame carries, where the current frame is the last frame in the current transaction and is an incomplete frame. Here, the unused parity bits 1922 have a value set to 2b′10 (decimal 2) indicating that there are two valid data words in the incomplete frame.

According to certain aspects, the preamble 1912 transmitted before the last write frame of a transaction may have a value of 2′b00 when the last write data frame has less than the maximum number of data words and the last write data frame is terminated early. In the example 1900, the preamble 1912 transmitted before the truncated last write data frame has the 2′b00 value since the truncated last write data frame carries only two of the four possible data words.

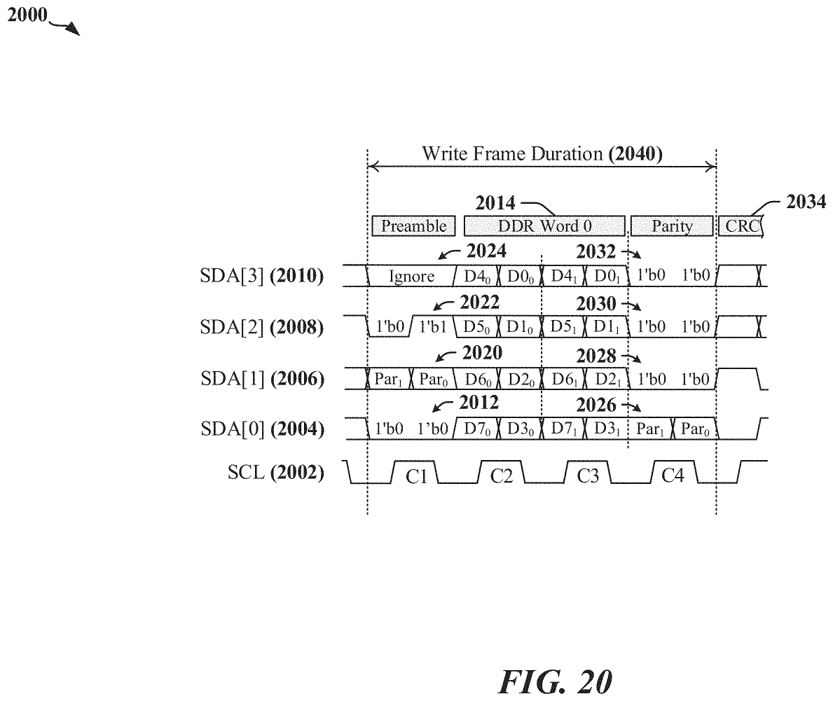

FIG. 20 illustrates an example 2000 in which a frame may be terminated early in accordance with certain aspects disclosed herein. In the example 2000, a multilane serial bus is operated in accordance with an I3C DDR protocol. The example 2000 relates to transmissions of write frames transmitted when a slave device is written by a bus master device in accordance with the I3C DDR protocol. In the example 2000, transmission of the frame is terminated early resulting in a frame duration 2040 that is truncated with respect to the duration of transmission of a full frame. When a transmission is truncated, the final data block 2014 may be followed by a CRC word 2034, an HDR Restart pattern and/or an HDR EXIT pattern. The example 2000 in FIG. 20 illustrated the transmission of the CRC word 2034 for illustrative purposes only.

Three additional wires are used for transmission of the frame and communication proceeds using five wires (SCL 2002, SDA[0] 2004, SDA[0] 2006 and SDA[1] 2008). One valid data word 2014a is transmitted. The data word 2014a may be transmitted after a two-bit preamble 2012 is transmitted on SDA[0] 2004. Here, both bits of the preamble 2012 are set to 1′b0 to indicate that the frame is the last frame in a transaction. A two-bit parity field 2020 for the first data word 2014a is transmitted on SDA[1] 2006 concurrently with the preamble 2012, and repeated (as the parity for the final data word 2014b) on SDA[0] 2004 after the data word 2014a has been transmitted. The frame is followed by transmission of a CRC word 2034.

According to certain aspects of this disclosure, validity indicators 2028, 2030, 2032 may be transmitted on SDA[1] 2006, SDA[2] 2008, and SDA[3] 2010 after the last valid data word 2014c has been transmitted. The value of the bits in the validity indicators 2028, 2030, 2032 indicate whether words are to be transmitted after the first data word 2014a. In the illustrated example 2000, the bits of the three validity indicators 2028, 2030, 2032 are set to 1′b0 indicating that potential second, third and fourth data words are not being transmitted. In this example 2000, transmission of the frame is terminated after the first data word 2014a has been transmitted. The corresponding unused parity bits 2022, 2024 can be repurposed to carry control information when the third and fourth data words are not transmitted. In the illustrated example, the unused parity bits 2022 are repurposed to indicate the number of valid data words provided in the current frame carries, where the current frame is the last frame in the current transaction and is an incomplete frame. Here, the unused parity bits 2022 have a value set to 2b′01 (decimal 1) indicating that there is one valid data word in the incomplete frame.

According to certain aspects, the preamble 2012 transmitted before the last write frame of a transaction may have a value of 2′b00 when the last write data frame has less than the maximum number of data words and the last write data frame is terminated early. In the example 2000, the preamble 2012 transmitted before the truncated last write data frame has the 2′b00 value since the truncated last write data frame carries only one of the four possible data words.

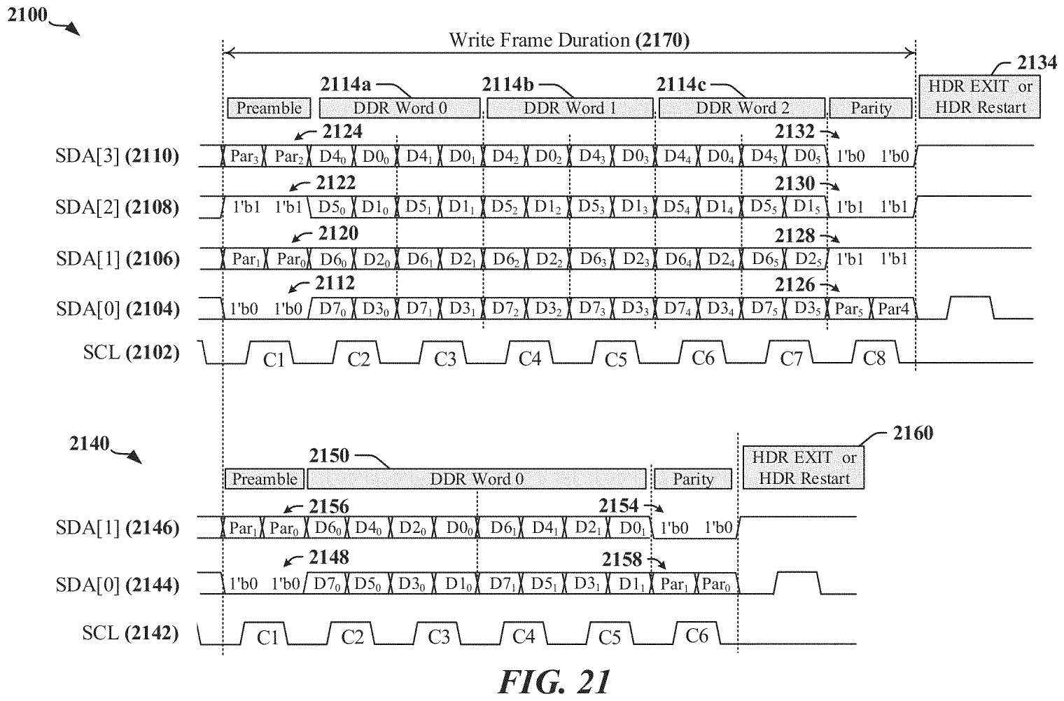

FIG. 21 illustrates examples 2100, 2140 in which frames may be terminated early in accordance with certain aspects disclosed herein. In the examples 2100, 2140, a multilane serial bus is operated in accordance with an I3C DDR protocol. The examples 2100, 2140 relate to transmissions of write frames transmitted when a slave device is written by a bus master device in accordance with the I3C DDR protocol. In each example 2100, 2140, transmission of the frame is terminated early resulting in a frame duration 2170 that is truncated with respect to the duration of transmission of a full frame. When a transmission is truncated, the final data word 1614b, 1650 may be followed by a CRC word and/or HDR Restart/Exit pattern 1630, 1660. The examples 1600, 1640 in FIG. 16 illustrate transmission of the HDR Restart/Exit pattern 1630, 1660 for illustrative purposes only.

In the first example 2140, one additional wire is used and communication proceeds using three wires (SCL 2142, SDA[0] 2144 and SDA[1] 2146). In this example 2140, transmission is terminated after the sole valid data word 2150 is transmitted. The word 2150 may be transmitted after a preamble 2148 is transmitted on SDA[0] 2124. In this example, the preamble 2148 indicates that the current, last data frame is incomplete and includes only one of the two possible data words using a 2′b00 value for the preamble 2148. Here, both bits of the preamble 2148 are set to 1′b0 to indicate that the frame is the last frame and has only one valid word. A two-bit parity field 2156 for the valid data word 2150 is transmitted on SDA[1] 2146 concurrently with the preamble 2148. The parity for the valid data word 2150 is also transmitted on SDA[0] 2104 immediately after the data word 2150 is transmitted. The frame is followed by transmission of a CRC word 2160.

According to certain aspects of this disclosure, validity indicators are transmitted on SDA[1] 2146. In one example, a validity indicator 2154 is transmitted on SDA[1] 2146 immediately after the data word 2150 is transmitted. The value of the bits in the validity indicator 2154 indicate whether a second word is to be transmitted. In the illustrated example 2140, both bits are set to 1′b0 indicating that, for example, insufficient data is available to transmit a second word. Frame transmission is terminated after the valid data word 2150 and parity has been transmitted.

In a second example 2100, three additional wires are used and communication proceeds using five wires (SCL 2102, SDA[0] 2104, SDA[0] 2106 and SDA[1] 2108). In this example 2100, three valid data words 2114a, 2114b, 2114c are transmitted when each conventional frame is configured to carry 4 words. The data words 2114a, 2114b, 2114c may be transmitted after a two-bit preamble 2112 is transmitted on SDA[0] 2104. Here, both bits of the preamble 2112 are set to 1′b0 to indicate that the frame is the last frame, and that the frame is an incomplete frame. Two-bit parity fields 2120, 2124 for the first two data words 2114a, 2114b, respectively, are transmitted on SDA[1] 2106 and SDA [3] 2110 concurrently with the preamble 2112. A two-bit parity field 2126 for the final data word 2114c is transmitted on SDA[0] 2104 after the last valid data word 2114c has been transmitted. The frame is followed by transmission of a CRC word 2134.

According to certain aspects of this disclosure, validity indicators 2128, 2130, 2132 may be transmitted on SDA[1] 2106, SDA[2] 2108, and SDA[3] 2110 after the last valid data word 2114c has been transmitted. The value of the bits in the validity indicators 2128, 2130, 2132 indicate whether words are to be transmitted after the first data word 2114a. In the illustrated example 2100, both bits of two validity indicators 2128, 2130 are set to 1′b1 indicating that the second word 2114b and the third word 2114c are valid. The bits of the other validity indicator 2132 are set to 1′b0 indicating that the potential fourth data word is not being transmitted. In this example 2100, transmission of the frame is terminated after the third data word 2114c has been transmitted. The corresponding unused parity bits 2122 can be repurposed to carry control information when the fourth data word is not transmitted. In the illustrated example, the unused parity bits 2122 are repurposed to indicate the number of valid data words provided in the current frame carries, where the current frame is the last frame in the current transaction and is an incomplete frame. Here, the unused parity bits 2122 have a value set to 2b′11 (decimal 3) indicating that there are three valid data words in the incomplete frame.

According to certain aspects, the preamble 2112, 2148 transmitted before the last write frame of a transaction may have a value of 2′b00 when the last write data frame has less than the maximum number of data words and the last write data frame is terminated early. In the first example 2140, the preamble 2148 transmitted before the truncated last write data frame has a value of 2′b00 when the truncated last write data frame carries only one valid data word of the two possible data words per frame. In the second example 2100, the preamble 2112 transmitted before the truncated last write data frame has a value of 2′b00 since the truncated last write data frame carries three data words, one less than the four possible data words.

Interoperability with Fast-Ending DDR Transmissions

The frame structures illustrated in FIGS. 14 and 17 maintain bus cadence when a serial bus is operated in accordance with an I3C HDR-DDR protocol and when insufficient data is available to fill the last transmitted frame. Padding may be used with these frame structures such that legacy devices and/or devices that do not support multilane operation can join directly in a multilane transaction. The padding may be added in the last data block of multilane transactions when the number of data words are not a multiple of 2 for dual data-lane implementations, or a multiple of 4 for quad data-lane implementations. The use of padding maintains compatibility with transmissions used in non-multilane implementations, with reduced or similar overhead with respect to truncated frames for data transfers of 15 or more data words.

Truncated multilane frames may cause certain interoperability issues. For example, the frame structures illustrated in FIGS. 14-16 and 18-20 are truncated frames that include transmission of a CRC frame (see CRC word 1530, 1560 in FIG. 15 for example). The transmission of a CRC frame is illustrated in FIG. 13. The transmission of the CRC frame 1314 includes a multi-bit transmission that includes a preamble 1312 and a CRC frame 1314 is transmitted after the last data frame in a transaction, followed by an HDR Exit or HDR Restart. Six clock pulses are transmitted on SCL 1302 during transmission of the CRC frame.

In some implementations, legacy devices and/or devices that do not support multilane operation may attempt to intervene in a transmission through the assertion of an in-band-interrupt, for example. In one example, an in-band interrupt is permitted by conventional I3C HDR protocols at certain points after a frame has been transmitted. A device that does not support multilane operation may attempt to intervene at clock pulse determined by full-frame cadence, and when the CRC transmission is in progress. In-band interrupts require transmitting devices to enter a high-impedance and/or open-drain mode of operation to provide in-band interrupt opportunities, and the unexpected assertion can cause a collision of line drivers.

In one solution disclosed herein, a truncated frame is terminated immediately with the HDR Exit or HDR Restart pattern, as illustrated in FIGS. 16 and 21. In these examples, data transfer is terminated immediately after the last valid word of a truncated frame denying the opportunity for intervention to legacy devices and/or devices that do not support multilane operation. This approach explicitly indicates the interruption of cadence to the legacy devices and/or devices that do not support multilane operation. In these example, the CRC is not transmitted, and integrity of the data transfer can be negatively impacted. The probability of error increases with longer transactions when CRC is not transmitted.

Certain aspects disclosed herein enables a truncated final frame to be transmitted with a CRC in a manner that avoids mistimed intervention by legacy devices and/or devices that do not support multilane operation. Certain aspects are applicable to SDR and DDR modes of transmission. The truncated final frame is terminated immediately after the last valid byte or word, and the CRC is transmitted across multiple lanes of the multilane interface, thereby requiring fewer clock signals on SCL.

The final frame of a DDR transaction may be truncated at a byte or word boundary. Certain DDR protocols, including the I3C HDR-DDR protocol, provide for data transfer in multiples of two bytes consolidated as data words. In some instances, including certain imaging and video-related applications, data is structured in 8-bit bytes. According to certain aspects disclosed herein, when an odd number of bytes are to be carried in a frame transmitted over a multilane serial bus operated in accordance with a DDR protocol, the preamble field may be used to indicate that frame is truncated and the byte location at which truncation occurs. In some implementations, a two-bit preamble field corresponding to a DDR word may be encoded to indicate validity of words and/or validity of the bytes within a word. In one example, the preamble field is encoded with the value 2′b11 to indicate a valid word, 2′b00 to indicate a valid word, and 2′b10 to indicate that one byte of a word is valid. Other encoding schemes may be used.

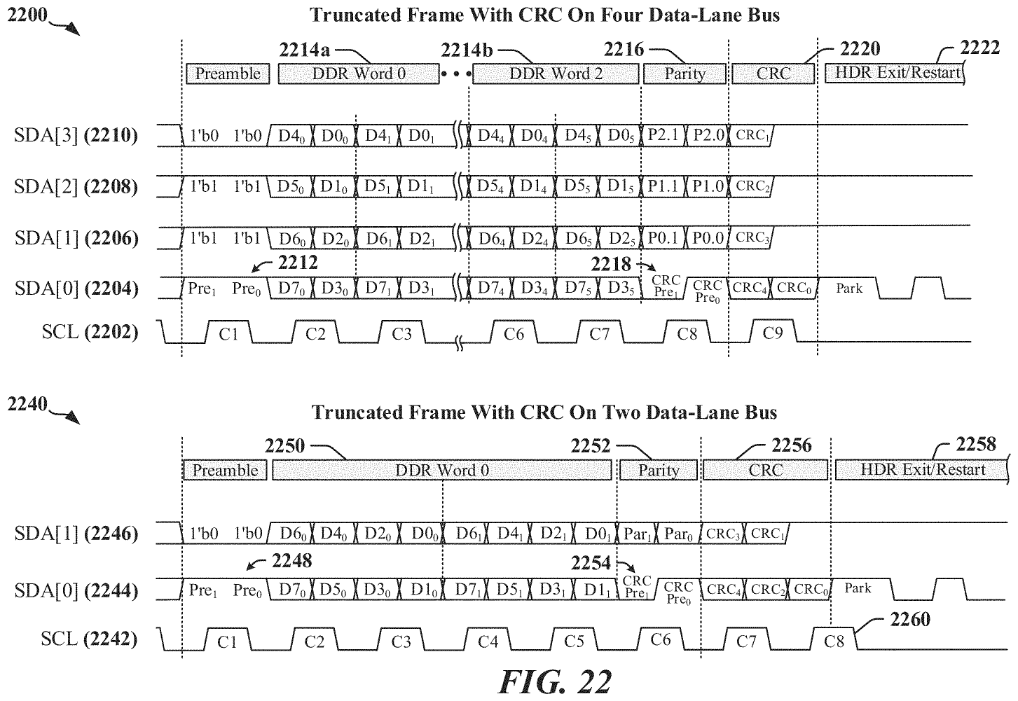

FIG. 22 illustrates an example of a first truncated frame 2200 transmitted over a 4-datalane I3C bus with a CRC provided in accordance with certain aspects disclosed herein. The first truncated frame 2200 may correspond to the frame of the second example 1800 illustrated in FIG. 18. The first truncated frame 2200 carries three words, including the first-transmitted word 2214a and the last-transmitted word 2214b. The 4-datalane I3C bus includes three additional wires are used and communication proceeds using five wires (SCL 2202, SDA[0] 2204, SDA[1] 2206, SDA[2] 2208 and SDA[3] 2210). The first-transmitted word 2214a may be preceded by a two-bit preamble 2212 that is transmitted on SDA[0] 2204. Parity for the transmitted data words is transmitted in a parity field 2216 using SDA[1] 2206, SDA[2] 2208 and SDA[3] 2210 after the last-transmitted word 2214b has been transmitted.

The frame is followed by transmission of a CRC 2220. CRC preamble bits 2218 or additional control bits can be transmitted on SDA[0] 2204. In some examples, the CRC preamble bits 2218 are transmitted to affirm that the CRC 2220 follows. In other examples, the CRC preamble bits 2218 may be reassigned to carry other information concerning the nature of the CRC 2220. In other examples, the CRC preamble bits 2218 may be reassigned to enable efficient transmission of a larger CRC 2220 or, in one example, two 5-bit CRCs without the need for additional clock pulses. The bits of the CRC 2220 are transmitted across all data lanes 2204, 2206, 2208, 2210 using one clock cycle. The CRC 2220 is followed by I3C HDR Exit of HDR Restart signaling 2222. In the illustrated example, the CRC 2220 is encoded in 5 bits, with the last-transmitted CRC bit being transmitted on SDA[0] 2204. In some implementations, more than 5 CRC bits can be transmitted. For example, a CRC 2220 having up to 8 bits may be transmitted in a single clock cycle. In another example, one or more CRCs with a total of up to 16 bits can be transmitted in two clock cycles.

FIG. 22 also illustrates an example of a second truncated frame 2240 transmitted over a 2-datalane I3C bus with a CRC provided in accordance with certain aspects disclosed herein. The second truncated frame 2240 may correspond to the frame of the first example 1840 illustrated in FIG. 18. The second truncated frame 2240 carries a single word 2250. The 2-datalane I3C bus includes one additional wires are used and communication proceeds using three wires (SCL 2242, SDA[0] 2244 and SDA[1] 2246). The word 2250 may be preceded by a two-bit preamble 2248 that is transmitted on SDA[0] 2244. Parity for the transmitted data words is transmitted in a parity field 2252 using SDA[1] 2246 after the word 2250 has been transmitted.

The frame is followed by transmission of a CRC 2256. CRC preamble bits 2254 or additional control bits can be transmitted on SDA[0] 2244. In some examples, the CRC preamble bits 2254 are transmitted to affirm that the CRC 2256 follows. In other examples, the CRC preamble bits 2254 may be reassigned to carry other information concerning the nature of the CRC 2256. In other examples, the CRC preamble bits 2254 may be reassigned to enable efficient transmission of a larger CRC 2256 or, in one example, two 5-bit CRCs without the need for additional clock pulses (i.e. using both edges of the final clock pulse 2260 (C8).

The bits of the CRC 2256 are transmitted across both data lanes 2244 and 2246 using 1.5 clock cycles. The CRC 2256 is followed by I3C HDR Exit of HDR Restart signaling 2258. In the illustrated example, the CRC 2256 is encoded in 5 bits, with two pairs of bits transmitted on SDA[0] 2244 and SDA[1] 2246 followed by the last-transmitted CRC bit transmitted on SDA[0] 2244. In some implementations, more than 5 CRC bits can be transmitted. For example, a CRC 2220 having up to 8 bits may be transmitted in the 1.5 clock cycles. In another example, one or more CRCs with a total of up to 12 bits can be transmitted in two clock cycles.

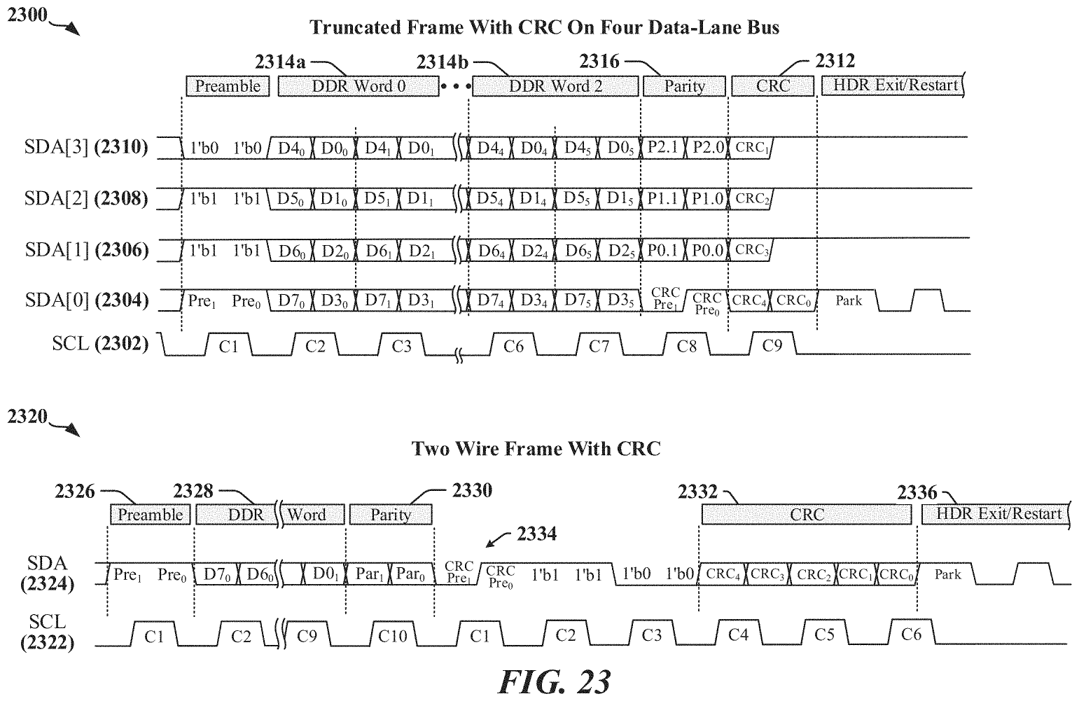

FIG. 23 provides a comparison of timing of a first frame 2300 that is truncated and transmitted over a four data-lane I3C bus with a CRC and a second frame 2320 that is transmitted over a single data lane I3C bus with a CRC in accordance with I3C protocols. The first frame 2300 corresponds to the first truncated frame 2200 in FIG. 22 and carries three words, including the first-transmitted word 2214a and the last-transmitted word 2214b, shown in FIG. 23 as 2314a and 2314b, respectively. Parity for the transmitted data words is transmitted in a parity field 2316, and the frame carries a CRC 2312 in a total of nine clock cycles.

The second frame 2320 carries a single word 2328 with a parity field 2330, and is not truncated. The I3C bus includes SCL 2322 and SDA 2324. The word 2328 may be preceded by a two-bit preamble 2326 that includes two bits transmitted on SDA 2324. Parity for the transmitted data words is transmitted in a parity field 2330 after the word 2328 has been transmitted. The frame is followed by transmission of a CRC frame 2332. CRC preamble bits 2334 are transmitted on SDA 2324 to indicate that the CRC frame 2332 follows. The bits of the CRC frame 2332 are transmitted using 2.5 clock cycles. The CRC frame 2332 is followed by I3C HDR Exit of HDR Restart signaling 2336. The entire transmission, including the CRC frame 2332 is transmitted using 16 clock pulses.

Certain aspects disclosed herein resolve cadence-related issues that can arise when legacy devices and/or devices that do not support multilane operation are coupled to some of the same wires that are coupled to a multilane device. In various examples, including those examples illustrated in FIG. 22, a truncated, last-transmitted frame that includes a CRC can be significantly shorter than a corresponding combination of a last data frame with a conventional CRC frame.

According to certain aspects, legacy devices and/or devices that do not support multilane operation cannot intervene at inappropriate or inopportune moments when the truncated frame, together with the CRC, are transmitted in fewer clock pulses than a full cadence frame.

### Examples of Processing Circuits and Methods

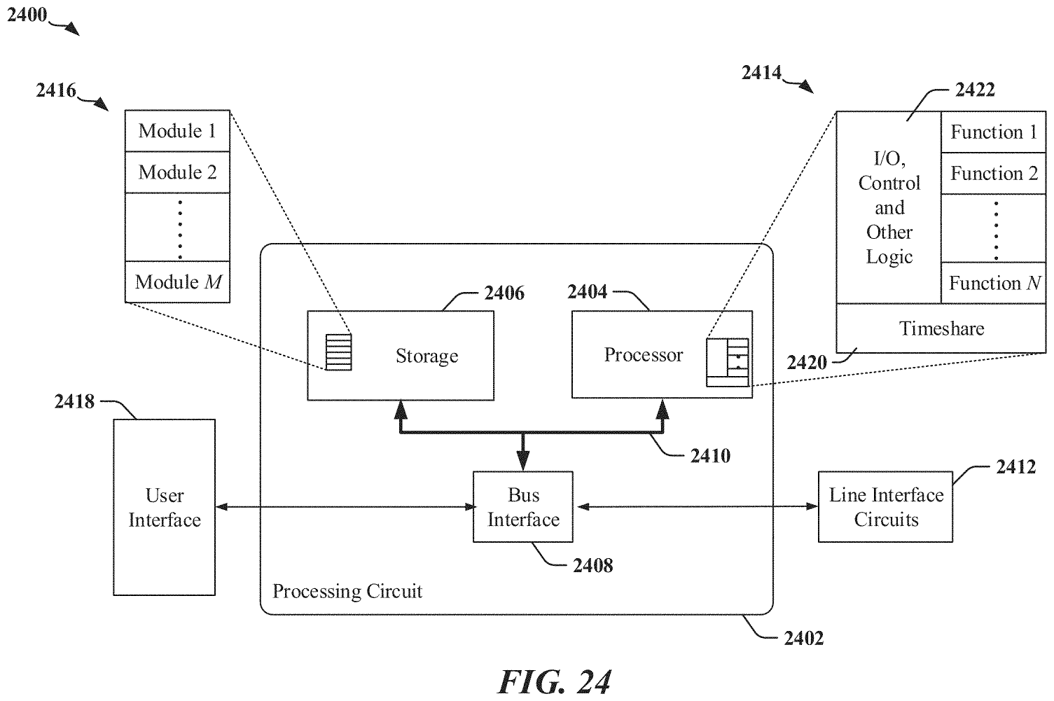

FIG. 24 is a diagram illustrating an example of a hardware implementation for an apparatus 2400 employing a processing circuit 2402 that may be configured to perform one or more functions disclosed herein. In accordance with various aspects of the disclosure, an element, or any portion of an element, or any combination of elements as disclosed herein may be implemented using the processing circuit 2402. The processing circuit 2402 may include one or more processors 2404 that are controlled by some combination of hardware and software modules. Examples of processors 2404 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 2404 may include specialized processors that perform specific functions, and that may be configured, augmented or controlled by one of the software modules 2416. The one or more processors 2404 may be configured through a combination of software modules 2416 loaded during initialization, and further configured by loading or unloading one or more software modules 2416 during operation. In various examples, the processing circuit 2402 may be implemented using a state machine, sequencer, signal processor and/or general-purpose processor, or a combination of such devices and circuits.

In the illustrated example, the processing circuit 2402 may be implemented with a bus architecture, represented generally by the bus 2410. The bus 2410 may include any number of interconnecting buses and bridges depending on the specific application of the processing circuit 2402 and the overall design constraints. The bus 2410 links together various circuits including the one or more processors 2404, and storage 2406. Storage 2406 may include memory devices and mass storage devices, and may be referred to herein as computer-readable media, computer-readable storage media, processor-readable media and/or processor-readable storage media. The bus 2410 may also link various other circuits such as timing sources, timers, peripherals, voltage regulators, and power management circuits. A bus interface 2408 may provide an interface between the bus 2410 and one or more transceivers 2412. A transceiver 2412 may be provided for each networking technology supported by the processing circuit. In some instances, multiple networking technologies may share some or all of the circuitry or processing modules found in a transceiver 2412. Each transceiver 2412 provides a means for communicating with various other apparatus over a transmission medium. Depending upon the nature of the apparatus 2400, a user interface 2418 (e.g., keypad, display, speaker, microphone, joystick) may also be provided, and may be communicatively coupled to the bus 2410 directly or through the bus interface 2408.

A processor 2404 may be responsible for managing the bus 2410 and for general processing that may include the execution of software stored in a computer-readable medium that may include the storage 2406. In this respect, the processing circuit 2402, including the processor 2404, may be used to implement any of the methods, functions and techniques disclosed herein. The storage 2406 may be used for storing data that is manipulated by the processor 2404 when executing software, and the software may be configured to implement any one of the methods disclosed herein.

One or more processors 2404 in the processing circuit 2402 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2406 or in an external computer-readable medium. The external computer-readable medium and/or storage 2406 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 2406 may also include, by way of example, a carrier wave, a transmission line, and any other suitable medium for transmitting software and/or instructions that may be accessed and read by a computer. Computer-readable medium and/or the storage 2406 may reside in the processing circuit 2402, in the processor 2404, external to the processing circuit 2402, or be distributed across multiple entities including the processing circuit 2402. The computer-readable medium and/or storage 2406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2406 may maintain software maintained and/or organized in loadable code segments, modules, applications, programs, etc., which may be referred to herein as software modules 2416. Each of the software modules 2416 may include instructions and data that, when installed or loaded on the processing circuit 2402 and executed by the one or more processors 2404, contribute to a run-time image 2414 that controls the operation of the one or more processors 2404. When executed, certain instructions may cause the processing circuit 2402 to perform functions in accordance with certain methods, algorithms and processes described herein.

Some of the software modules 2416 may be loaded during initialization of the processing circuit 2402, and these software modules 2416 may configure the processing circuit 2402 to enable performance of the various functions disclosed herein. For example, some software modules 2416 may configure internal devices and/or logic circuits 2422 of the processor 2404, and may manage access to external devices such as the transceiver 2412, the bus interface 2408, the user interface 2418, timers, mathematical coprocessors, and so on. The software modules 2416 may include a control program and/or an operating system that interacts with interrupt handlers and device drivers, and that controls access to various resources provided by the processing circuit 2402. The resources may include memory, processing time, access to the transceiver 2412, the user interface 2418, and so on.

One or more processors 2404 of the processing circuit 2402 may be multifunctional, whereby some of the software modules 2416 are loaded and configured to perform different functions or different instances of the same function. The one or more processors 2404 may additionally be adapted to manage background tasks initiated in response to inputs from the user interface 2418, the transceiver 2412, and device drivers, for example. To support the performance of multiple functions, the one or more processors 2404 may be configured to provide a multitasking environment, whereby each of a plurality of functions is implemented as a set of tasks serviced by the one or more processors 2404 as needed or desired. In one example, the multitasking environment may be implemented using a timesharing program 2420 that passes control of a processor 2404 between different tasks, whereby each task returns control of the one or more processors 2404 to the timesharing program 2420 upon completion of any outstanding operations and/or in response to an input such as an interrupt. When a task has control of the one or more processors 2404, the processing circuit is effectively specialized for the purposes addressed by the function associated with the controlling task. The timesharing program 2420 may include an operating system, a main loop that transfers control on a round-robin basis, a function that allocates control of the one or more processors 2404 in accordance with a prioritization of the functions, and/or an interrupt driven main loop that responds to external events by providing control of the one or more processors 2404 to a handling function.

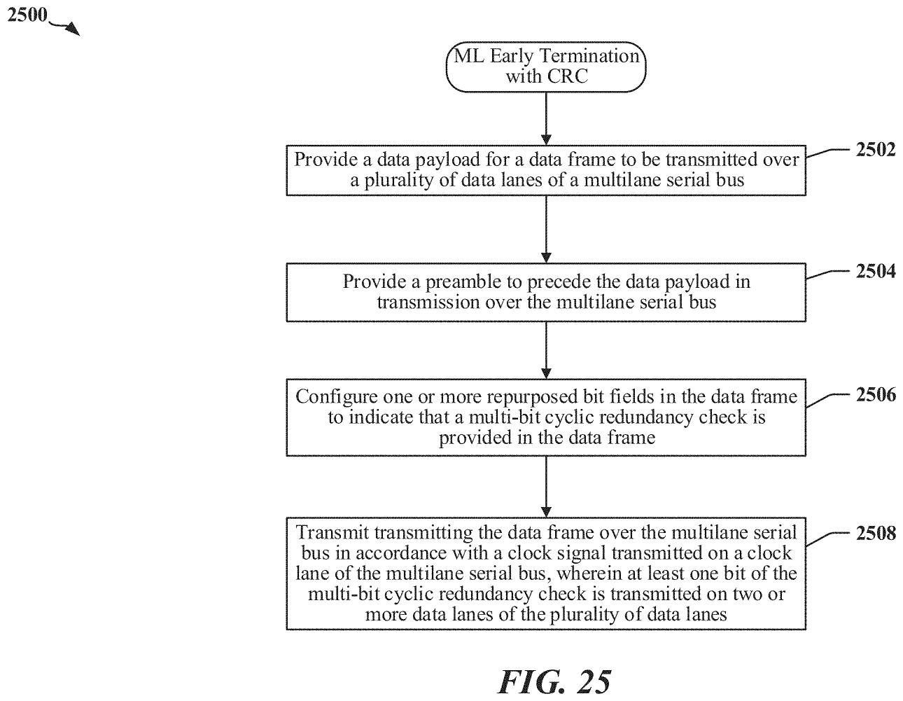

FIG. 25 is a flowchart 2500 illustrating a process that may be performed at a device coupled to a multilane serial bus. At block 2502, the device may provide a data payload for a data frame to be transmitted over a plurality of data lanes of a multilane serial bus. In some instances, the multilane serial bus is operated in an I3C double data rate protocol. At block 2504, the device may provide a preamble to precede the data payload in transmission over the multilane serial bus. At block 2506, the device may configure one or more repurposed bit fields in the data frame to indicate that a multi-bit cyclic redundancy check is provided in the data frame. At block 2508, the device may transmit the data frame over the multilane serial bus in accordance with a clock signal transmitted on a clock lane of the multilane serial bus. In one example, at least one bit of the multi-bit cyclic redundancy check is transmitted on two or more data lanes of the plurality of data lanes.

In one example, the data frame is a read frame and the one or more repurposed bit fields are transmitted concurrently with parity for the data payload. In another example, the data frame is a write frame and the one or more repurposed bit fields are transmitted concurrently with parity information after transmission of the data payload. The one or more repurposed bit fields may include a cyclic redundancy check preamble.

In some examples, the multilane serial bus has a primary data lane and three additional data lanes. A fully-loaded data frame may carry four words as a data payload. The data payload may be provided with fewer than four valid data words, and at least five bits may be transmitted in the multi-bit cyclic redundancy check. The transmission of the data frame may be terminated after transmitting fewer than four valid data words. In one example, the preamble may be configured with a value that indicates that a truncated data frame is being terminated early, the truncated data frame having fewer than the maximum number of data words.

In certain examples, the device may transmit a plurality of commands on the bus. Each command may select a mode of operation to be used by one or more devices when communicating over the serial bus, and the number of additional lines used by the one or more devices for data transmissions in the corresponding selected mode of operation. Different devices may be configured to communicate using different modes of operation. In some instances, a first device may receive a first command that causes the device to operate in a first mode of operation using a first number of wires. The first device may use the first mode of operation and the first number of wires for multiple transactions conducted over the bus. In some instances, the first device may continue to use the first mode of operation and the first number of wires until a second command causes the first device to operate in a second mode of operation and/or to use a second number of wires.

Each command may be transmitted in the first mode of operation. The device may transmit one or more commands operative to configure each device in the two or more devices to support a number of data lanes. The device may ascertain a number of available lines coupled to each of the two or more devices. The device may configure each slave device to use at least some of the available lines in the second mode of operation. The device may dynamically adapt a protocol used in the second mode of operation to utilize a corresponding number of the available lines when communicating with each slave device. The protocol used in the second mode of operation is adapted to use a varying number of lines to encode symbols for transmission.

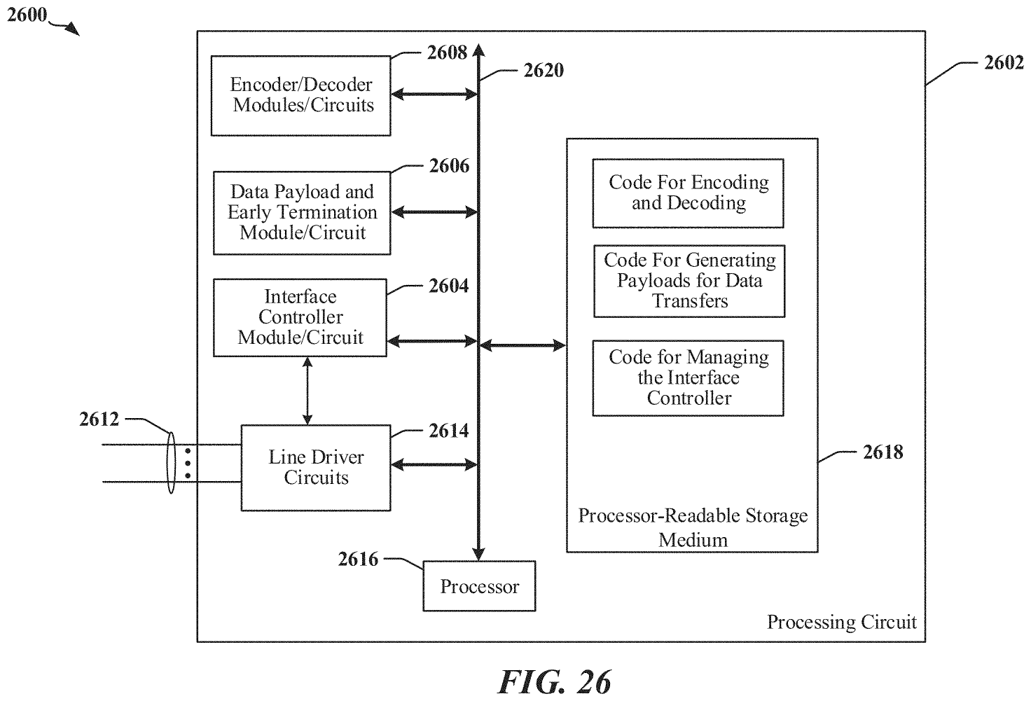

FIG. 26 is a diagram illustrating a simplified example of a hardware implementation for an apparatus 2600 employing a processing circuit 2602. The processing circuit typically has a controller or processor 2616 that may include one or more microprocessors, microcontrollers, digital signal processors, sequencers and/or state machines. The processing circuit 2602 may be implemented with a bus architecture, represented generally by the bus 2620. The bus 2620 may include any number of interconnecting buses and bridges depending on the specific application of the processing circuit 2602 and the overall design constraints. The bus 2620 links together various circuits including one or more processors and/or hardware modules, represented by the controller or processor 2616, the modules or circuits 2604, 2606 and 2608, and the processor-readable storage medium 2618. The apparatus may be coupled to a multi-lane communication link using a physical layer circuit 2614. The physical layer circuit 2614 may operate the multi-lane communication link 2612 to support communications in accordance with I3C protocols. The bus 2620 may also link various other circuits such as timing sources, peripherals, voltage regulators, and power management circuits, which are well known in the art, and therefore, will not be described any further.

The processor 2616 is responsible for general processing, including the execution of software, code and/or instructions stored on the processor-readable storage medium 2618. The processor-readable storage medium 2618 may include a non-transitory storage medium. The software, when executed by the processor 2616, causes the processing circuit 2602 to perform the various functions described supra for any particular apparatus. The processor-readable storage medium 2618 may be used for storing data that is manipulated by the processor 2616 when executing software. The processing circuit 2602 further includes at least one of the modules 2604, 2606 and 2608. The modules 2604, 2606 and 2608 may be software modules running in the processor 2616, resident/stored in the processor-readable storage medium 2618, one or more hardware modules coupled to the processor 2616, or some combination thereof. The modules 2604, 2606 and 2608 may include microcontroller instructions, state machine configuration parameters, or some combination thereof.

In one configuration, the apparatus 2600 includes an interface controller 2604, and line driver circuits 2614 including a first line driver coupled to a first wire of a multi-lane serial bus and a second line driver coupled to a second wire of the multi-lane serial bus. The apparatus 2600 may include modules and/or circuits 2604, 2608, 2614 configured to transmit data over the serial bus while the multi-lane serial bus is configured for a DDR mode of operation. The apparatus 2600 may include modules and/or circuits 2606, configured to configure data payloads and control information in each data frame.

In one implementation, a processor 2616 of the apparatus 2600 may be configured to provide a data payload for a data frame to be transmitted over a plurality of data lanes of a multilane serial bus operated in accordance with an I3C protocol, provide a preamble to precede the data payload in transmission over the multilane serial bus, configure one or more repurposed bit fields in the first data frame as indicators of validity of one or more words included in the data payload, and transmit the data frame over the multilane serial bus in accordance with a clock signal transmitted on a clock lane of the multilane serial bus.

The data frame may be a read frame and the one or more repurposed bit fields are transmitted concurrently with the preamble. The processor 2616 may be configured to transmit the preamble on a first data lane, and transmit the one or more repurposed bit fields concurrently on at least one additional data lane.

The data frame may be a write frame and the one or more repurposed bit fields may be transmitted concurrently with parity information after transmission of the data payload. The processor 2616 may be configured to transmit the parity information on a first data lane, and transmit the one or more repurposed bit fields concurrently on at least one additional data lane. The parity information may be transmitted on a first data lane and the one or more repurposed bit fields are transmitted concurrently on at least one additional data lane.

In one example, the multilane serial bus includes a primary data lane and three additional data lanes. A fully-loaded data frame may carry a four-word data payload. The processor 2616 may be configured to provide fewer than four valid data words in the payload, and configure the one or more repurposed bit fields to indicate that fewer than four valid data words are in the payload. The processor 2616 may be configured to terminate the data frame after the valid data words in the payload have been transmitted.

The processor-readable storage medium 2618 may include instructions or code that cause the processing circuit 2602 to perform certain of the methods or functions disclosed herein. The processor-readable storage medium 2618 may include instructions or code for providing a data payload for a data frame to be transmitted over a plurality of data lanes of a multilane serial bus, providing a preamble to precede the data payload in transmission over the multilane serial bus, configuring one or more repurposed bit fields in the data frame to indicate that a multi-bit cyclic redundancy check is provided in the data frame, and transmitting the data frame over the multilane serial bus in accordance with a clock signal transmitted on a clock lane of the multilane serial bus. At least one bit of the multi-bit cyclic redundancy check may be transmitted on each of two or more data lanes of the plurality of data lanes.

The data frame may be a read frame in which the one or more repurposed bit fields are transmitted concurrently with parity for the data payload. The one or more repurposed bit fields may include a cyclic redundancy check preamble. The data frame may be a write frame in which the one or more repurposed bit fields are transmitted concurrently with parity information after transmission of the data payload. The multilane serial bus may have a primary data lane and three additional data lanes, and a fully-loaded data frame may carry four words as a data payload. In some instances, the processor-readable storage medium 2618 may include instructions or code for providing fewer than four valid data words as the data payload, and transmitting at least five bits in the multi-bit cyclic redundancy check.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method, comprising:
providing a data payload for a data frame to be transmitted over a plurality of data lanes of a multilane serial bus;
providing a preamble to precede the data payload in transmission over the multilane serial bus;
configuring one or more repurposed bit fields in the data frame to indicate that a multi-bit cyclic redundancy check is provided in the data frame; and
transmitting the data frame over the multilane serial bus in accordance with a clock signal transmitted on a clock lane of the multilane serial bus,
wherein at least one bit of the multi-bit cyclic redundancy check is transmitted on each of two or more data lanes of the plurality of data lanes.

2. The method of claim 1, wherein the data frame is a read frame and the one or more repurposed bit fields are transmitted concurrently with parity for the data payload.

3. The method of claim 1, wherein the one or more repurposed bit fields includes cyclic redundancy check bits.

4. The method of claim 1, wherein the data frame is a write frame and the one or more repurposed bit fields are transmitted concurrently with parity information after transmission of the data payload.

5. The method of claim 1, wherein the multilane serial bus comprises a primary data lane and three additional data lanes, and wherein a fully-loaded data frame carries four words as its payload, each word comprising two 8-bit bytes.

6. The method of claim 5, wherein providing the data payload comprises:
providing fewer than eight valid data bytes as the data payload; and
transmitting at least five bits in the multi-bit cyclic redundancy check.

7. The method of claim 6, further comprising:
terminating transmission of the data frame after transmitting the fewer than eight valid data bytes.

8. The method of claim 1, further comprising:
terminating transmission of the data frame early when the data frame includes fewer than a maximum number of data bytes configured for the data frame; and
configuring the preamble with a value that indicates that a truncated data frame is being terminated early, the truncated data frame comprising fewer than the maximum number of data bytes.

9. The method of claim 1, wherein the multilane serial bus is operated in an I3C double data rate protocol.

10. An apparatus, comprising:
a bus interface configured to couple the apparatus to a multilane serial bus; and
a processor configured to:
provide a data payload for a data frame to be transmitted over a plurality of data lanes of the multilane serial bus;
provide a preamble to precede the data payload in transmission over the multilane serial bus;
configure one or more repurposed bit fields in the data frame to indicate that a multi-bit cyclic redundancy check is provided in the data frame; and
transmit the data frame over the multilane serial bus in accordance with a clock signal transmitted on a clock lane of the multilane serial bus,
wherein at least one bit of the multi-bit cyclic redundancy check is transmitted on each of two or more data lanes of the plurality of data lanes.

11. The apparatus of claim 10, wherein the data frame is a read frame and the one or more repurposed bit fields are transmitted concurrently with parity for the data payload.

12. The apparatus of claim 10, wherein the one or more repurposed bit fields includes cyclic redundancy check bits.

13. The apparatus of claim 10, wherein the data frame is a write frame and the one or more repurposed bit fields are transmitted concurrently with parity information after transmission of the data payload.

14. The apparatus of claim 10, wherein the multilane serial bus comprises a primary data lane and three additional data lanes, and wherein a fully-loaded data frame carries four words as its payload, each word comprising two 8-bit bytes.

15. The apparatus of claim 14, wherein the processor is further configured to:
provide fewer than eight valid data bytes as the data payload; and
transmit at least five bits in the multi-bit cyclic redundancy check.

16. The apparatus of claim 15, wherein the processor is further configured to:
terminate transmission of the data frame after transmitting the fewer than eight valid data bytes.

17. The apparatus of claim 10, wherein the processor is further configured to:
terminate transmission of the data frame early when the data frame includes fewer than a maximum number of data bytes configured for the data frame; and
configure the preamble with a value that indicates that a truncated data frame is being terminated early, the truncated data frame comprising fewer than the maximum number of data bytes.

18. The apparatus of claim 10, wherein the multilane serial bus is operated in an I3C double data rate protocol.

19. An apparatus, comprising:
means for providing a data payload for a data frame to be transmitted over a plurality of data lanes of a multilane serial bus;
means for providing a preamble to precede the data payload in transmission over the multilane serial bus;
means for configuring one or more repurposed bit fields in the data frame to indicate that a multi-bit cyclic redundancy check is provided in the data frame; and
means for transmitting the data frame over the multilane serial bus in accordance with a clock signal transmitted on a clock lane of the multilane serial bus,
wherein at least one bit of the multi-bit cyclic redundancy check is transmitted on each of two or more data lanes of the plurality of data lanes.

20. The apparatus of claim 19, wherein the data frame is a read frame and the one or more repurposed bit fields are transmitted concurrently with parity for the data payload.

21. The apparatus of claim 19, wherein the one or more repurposed bit fields includes cyclic redundancy check bits.

22. The apparatus of claim 19, wherein the data frame is a write frame and the one or more repurposed bit fields are transmitted concurrently with parity information after transmission of the data payload.

23. The apparatus of claim 19, wherein the multilane serial bus comprises a primary data lane and three additional data lanes, and wherein a fully-loaded data frame carries four words as its payload, each word comprising two 8-bit bytes.

24. The apparatus of claim 23, wherein the means for providing the data payload is configured to provide fewer than eight valid data bytes as the data payload and the means for transmitting the data frame is configured to transmit at least five bits in the multi-bit cyclic redundancy check.

25. A processor-readable storage medium comprising code for:
providing a data payload for a data frame to be transmitted over a plurality of data lanes of a multilane serial bus;
providing a preamble to precede the data payload in transmission over the multilane serial bus;
configuring one or more repurposed bit fields in the data frame to indicate that a multi-bit cyclic redundancy check is provided in the data frame; and
transmitting the data frame over the multilane serial bus in accordance with a clock signal transmitted on a clock lane of the multilane serial bus,
wherein at least one bit of the multi-bit cyclic redundancy check is transmitted on each of two or more data lanes of the plurality of data lanes.

26. The storage medium of claim 25, wherein the data frame is a read frame and the one or more repurposed bit fields are transmitted concurrently with parity for the data payload.

27. The storage medium of claim 25, wherein the one or more repurposed bit fields includes cyclic redundancy check bits.

28. The storage medium of claim 25, wherein the data frame is a write frame and the one or more repurposed bit fields are transmitted concurrently with parity information after transmission of the data payload.

29. The storage medium of claim 25, wherein the multilane serial bus comprises a primary data lane and three additional data lanes, and wherein a fully-loaded data frame carries four words as its payload, each word comprising two 8-bit bytes.

30. The storage medium of claim 29, further comprising code for:
providing fewer than eight valid data bytes as the data payload; and
transmitting at least five bits in the multi-bit cyclic redundancy check.
